(19) United States
(12) Patent Application Publication
(10) Pub. No.: US 2026/0340038 A1
(43) Pub. Date: Oct. 29, 2026

(54) SYSTEM AND METHOD FOR IMPLEMENTING SUSTAINABILITY INTERVENTIONS IN A SOCIAL ECOSYSTEM

(71) Applicant: Amrita Vishwa Vidyapeetham, Kollam (IN)

(72) Inventors: Maneesha Vinodini Ramesh, Kollam (IN); Krishna Nandanan, Coimbatore (IN); Sai Hari Chandana Ekkirala, Kollam (IN); Reshma A S, Thrissur (IN); Vineeth Ajith, Pathanamthitta (IN); Ramesh Guntha, Kollam (IN); Amrita Jayakumar, Kozhikode (IN)

(73) Assignee: Amrita Vishwa Vidyapeetham, Kollam (IN)

(21) Appl. No.: 19/286,043

(22) Filed: Jul. 30, 2025

(30) Foreign Application Priority Data
Apr. 26, 2025 (IN) 202541040498

(51) Int. Cl. G06F 16/901; G06F 16/906; G06Q 50/26

(52) U.S. Cl. CPC G06F 16/9027; G06F 16/906; G06Q 50/26

(57) ABSTRACT

The present disclosure relates to a system and method for implementing sustainability interventions in a social ecosystem. The method includes receiving data associated with thematic areas in the social, creating (1604) an indicator bank, determining a value corresponding to each of indicators in the indicator bank, and generating a first-level recommendation when the value of each of the indicators falls within a predefined range. Further, the method includes identifying interrelationships between the indicators in each of the thematic areas using Artificial Intelligence (AI) models, creating a system's map based on the identified interrelationships and generating a second-level recommendation based on the system's map. The generated first-level and second-level recommendations are indicative of the sustainability interventions, thereby the method promotes sustainable development through AI based recommendations.

### CROSS REFERENCE TO RELATED APPLICATIONS

The present application claims priority to an Indian Patent Application #202541040498 filed on Apr. 26, 2025. All disclosure of the parent application is incorporated at least by reference.

### TECHNICAL FIELD

The present disclosure generally relates to sustainability management systems, and more particularly relates to a system and method for implementing sustainability interventions in a social environment, thereby enhancing resource efficiency and promoting sustainable development through Artificial Intelligence (AI) based recommendations.

### BACKGROUND

Sustainability remains a pressing global challenge as communities grapple with complex and interdependent issues across multiple thematic areas, including water, energy, agriculture, health, and education. Existing sustainability models often focus on addressing individual challenges within specific thematic areas, without considering the interconnected nature of social, environmental, economic, and institutional factors. The fragmented approach can lead to unintended consequences where solutions in one sector create synergies or trade-offs in another, ultimately hampering long-term sustainability efforts.

Currently, there is a lack of comprehensive frameworks that integrate multi-thematic sustainability challenges into a unified system. Traditional approaches often rely on static threshold-based evaluations, providing only limited first-level recommendations that address isolated sustainability issues. However, such methods fail to capture the broader impact of interventions across different thematic areas.

Therefore, there is a need to address at least the above-mentioned drawbacks and any other shortcomings, or at the very least, provide a valuable alternative to the existing methods and systems.

### OBJECTS OF THE PRESENT DISCLOSURE

An object of the present disclosure relates to a system and method for implementing sustainability interventions in a social environment, thereby enhancing environmental resilience and developing community-driven decision-making for sustainable development.

Another object of the present disclosure is to provide a system for analyzing sustainability indicators and generating data-driven recommendations, thereby enabling stakeholders to implement effective sustainability interventions.

Another object of the present disclosure is to provide a system for prioritizing sustainability actions using decision models, thereby ensuring efficient allocation of resources and maximizing the impact of sustainability initiatives.

Yet another object of the present disclosure is to provide a dynamic visualization and dissemination, thereby facilitating real-time monitoring and stakeholder engagement.

### SUMMARY

Aspects of the present disclosure generally relates to sustainability management systems, and more particularly relates to a system and method for implementing sustainability interventions in a social environment, thereby enhancing resource efficiency and promoting sustainable development through Artificial Intelligence (AI) based recommendations.

An aspect of the present disclosure relates to a method for implementing sustainability interventions in a social ecosystem. The method may include receiving, by one or more processors associated with a system, data associated with a plurality of thematic areas in the social ecosystem using a plurality of sources associated with the system and creating, by the one or more processors, an indicator bank, and the indicator bank may include one or more indicators corresponding to each of the plurality of thematic areas. Further, determining, by the one or more processors, a value corresponding to each of the one or more indicators, generating, by the one or more processors, a first-level recommendation when the value of each of the one or more indicators falls within a predefined range and identifying, by the one or more processors, interrelationships between the one or more indicators in each of the plurality of thematic areas using a plurality of Artificial Intelligence (AI) models associated with the system upon generation of the first-level recommendation. Further, the method may include creating, by the one or more processors, a system's map based on the identified interrelationships and generating, by the one or more processors, a second-level recommendation based on the system's map, and the first-level and second-level recommendations may be indicative of the sustainability interventions.

In an embodiment, the interrelationships may include at least one of one-to-one relationships, one-to-many relationships, and many-to-many relationships.

In an embodiment, the method may include generating, by the one or more processors, a plurality of deep structures corresponding to each of the plurality of thematic areas based on the system's map to classify the one or more indicators of each of the plurality of thematic areas into synergies and trade-offs. The second-level recommendation may be generated based on the synergies and trade-offs.

In an embodiment, the method may include prioritizing, by the one or more processors, the first level and second level recommendations based on at least two approaches using the AI models and transmitting, by the one or more processors, the prioritized recommendations to one or more stakeholders associated with the social ecosystem for implementation of the sustainability interventions.

In an embodiment, the at least two approaches for prioritizing the recommendations may include a system-defined prioritization and a user-defined prioritization.

In an embodiment, the system-defined prioritization may include creating, by the one or more processors, a priority matrix based on the interrelationships identified between the one or more indicators and assigning, by the one or more processors, priority levels to each of the interrelationships based on a predefined criteria. Further, the method may include determining, by the one or more processors, if the priority levels exceed a predefined threshold and prioritizing, by the one or more processors, the first level recommendations and the second level recommendations upon a positive determination that the priority levels exceed the predefined threshold.

In an embodiment, the user-defined prioritization may include receiving, by one or more processors, a set of indicator responses associated with the one or more indicators, determining, by the one or more processors, a sub-index score for each of the one or more indicators based on the set of indicator responses and generating, by the one or more processors, an index score by aggregating the sub-index scores for each of the one or more indicators. Further, the method may include comparing, by the one or more processors, the sub-index scores and index scores against a set of predefined benchmarks and generating, by the one or more processors, one or more policies based on the indicator responses, sub-index scores, and index scores and the generated one or more policies may be utilized for user-defined prioritization.

In an embodiment, the method may include monitoring and assessing, by the one or more processors, an impact of the implemented sustainability interventions in real-time.

In an embodiment, the method may include updating, by the one or more processors, the system's map and recommendations based on real-time monitoring and assessing.

Another embodiment of the present disclosure may include a system for implementing sustainability interventions in a social ecosystem. The system may include one or more processors and a memory. The one or more processors may receive data associated with a plurality of thematic areas in the social ecosystem using a plurality of sources associated with the system, create an indicator bank, the indicator bank may include one or more indicators corresponding to each of the plurality of thematic areas, determine a value corresponding to each of the one or more indicators and generate a first-level recommendation when the value of each of the one or more indicators falls within a predefined range. Further, the one or more processors may identify interrelationships between the one or more indicators in each of the plurality of thematic areas using a plurality of Artificial Intelligence (AI) models associated with the system upon generation of the first-level recommendation, create a system's map based on the identified interrelationships and generate a second-level recommendation based on the system's map, and the first-level and second-level recommendations may be indicative of the sustainability interventions.

Various objects, features, aspects, and advantages of the inventive subject matter will become more apparent from the following detailed description of preferred embodiments, along with the accompanying drawing figures in which like numerals represent components.

### BRIEF DESCRIPTION OF THE DRAWINGS

FIG. 1A illustrates an exemplary network architecture 100A for implementing a system 102 for sustainability interventions in a social ecosystem, in accordance with an embodiment of the present disclosure.

FIG. 1B illustrates an exemplary block diagram of the system 102 for implementing the sustainability interventions in the social ecosystem, in accordance with an embodiment of the present disclosure.

FIG. 2 illustrates an example block diagram of a system architecture for implementing the sustainability interventions in the social ecosystem, in accordance with an embodiment of the present disclosure.

FIG. 3 illustrates a schematic representation of data exchange between a client and a server, in accordance with an embodiment of the present disclosure.

FIG. 4A illustrates an example flow chart of identifying indicators, in accordance with an embodiment of the present disclosure.

FIG. 4B illustrates an example flow chart of a method for developing indicators for data collection, in accordance with an embodiment of the present disclosure.

FIG. 4C illustrates a schematic representation of indicator data collection and weighting, in accordance with an embodiment of the present disclosure.

FIG. 5 illustrates an example block diagram of a process for identifying the indicators, in accordance with an embodiment of the present disclosure.

FIG. 6 illustrates an exemplary view of a system's map, in accordance with an embodiment of the present disclosure.

FIG. 7 illustrates an exemplary view of a deep structure, in accordance with an embodiment of the present disclosure.

FIG. 8 illustrates an example block diagram of a theme-based and comprehensive policy recommendations, in accordance with an embodiment of the present disclosure.

FIG. 9 illustrates an example flow diagram of indicator assessment and data processing, in accordance with an embodiment of the present disclosure.

FIG. 10 illustrates a schematic representation of a Sustainability and Resilience for community Engagement and Empowerment (SREE) framework, in accordance with an embodiment of the present disclosure.

FIG. 11 illustrates an example block diagram of a data processing and analysis system using the SREE framework, in accordance with an embodiment of the present disclosure.

FIG. 12 illustrates an example flow chart of a method of dissemination of policy recommendations to stakeholders, in accordance with an embodiment of the present disclosure.

FIG. 13 illustrates an example flow chart of a method of multi-stakeholder visualization based on recommendations, in accordance with an embodiment of the present disclosure.

FIG. 14 illustrates an example flow diagram of a method for implementing the sustainability interventions in the social ecosystem, in accordance with an embodiment of the present disclosure.

FIG. 15A illustrates a graphical representation of Pearson Correlation Matrix for the one-to-one relationship, in accordance with an embodiment of the present disclosure.

FIG. 15B illustrates a graphical representation of the Pearson Correlation Matrix for one-to-many relationships, in accordance with an embodiment of the present disclosure.

FIG. 15C illustrates a graphical representation of first Canonical Variables for many-to-many relationships, in accordance with an embodiment of the present disclosure.

FIG. 15D illustrates an example system's map for water availability and usage relationships, in accordance with an embodiment of the present disclosure.

FIG. 15E illustrates an example deep structure for water availability and usage relationships, in accordance with an embodiment of the present disclosure.

FIG. 15F illustrates an example decision tree for a second-level recommendation, in accordance with an embodiment of the present disclosure.

FIG. 16 illustrates a flow diagram illustrating the method for implementing sustainability interventions in the social ecosystem, in accordance with an embodiment of the present disclosure.

FIG. 17 illustrates a block diagram of an example computer system 1700 in which or with which embodiments of the present disclosure may be implemented.

### DETAILED DESCRIPTION

The following is a detailed description of embodiments of the disclosure depicted in the accompanying drawings. The embodiments are in such details as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

Embodiments of the present disclosure generally relates to sustainability management systems, and more particularly relates to a system and method for implementing sustainability interventions in a social environment, thereby enhancing resource efficiency and promoting sustainable development through Artificial Intelligence (AI) based recommendations.

An embodiment of the present disclosure relates to a method for implementing sustainability interventions in a social ecosystem. The method may include receiving, by one or more processors associated with a system, data associated with a plurality of thematic areas in the social ecosystem using a plurality of sources associated with the system and creating, by the one or more processors, an indicator bank, and the indicator bank may include one or more indicators corresponding to each of the plurality of thematic areas. Further, determining, by the one or more processors, a value corresponding to each of the one or more indicators, generating, by the one or more processors, a first-level recommendation when the value of each of the one or more indicators falls within a predefined range and identifying, by the one or more processors, interrelationships between the one or more indicators in each of the plurality of thematic areas using a plurality of Artificial Intelligence (AI) models associated with the system upon generation of the first-level recommendation. Further, the method may include creating, by the one or more processors, a system's map based on the identified interrelationships and generating, by the one or more processors, a plurality of deep structures corresponding to each of the plurality of thematic areas based on the system's map to classify the one or more indicators of each of the plurality of thematic areas into synergies and trade-offs. The second-level recommendation may be generated based on the synergies and trade-offs. Further, the method may include generating, by the one or more processors, a second-level recommendation based on the system's map, and the first-level and second-level recommendations may be indicative of the sustainability interventions. Further, the method may include prioritizing, by the one or more processors, the first level and second level recommendations based on at least two approaches using the AI models and transmitting, by the one or more processors, the prioritized recommendations to one or more stakeholders associated with the social ecosystem for implementation of the sustainability interventions.

In an embodiment, indicators may constitute social, economic, environmental, and institutional dimensions of sustainability in various thematic areas such as water, health, education, agriculture, and the like. The system's map may aid in visualizing complexity of systems, such as relationships, processes, interactions and interdependencies within the indicators. The causality as well as the correlation between the indicators may be established by the system's map. The deep structure may be derived from the system's map by identifying the most influential relationships and underlying patterns within the interconnected indicators, highlighting strongest connections among key indicators.

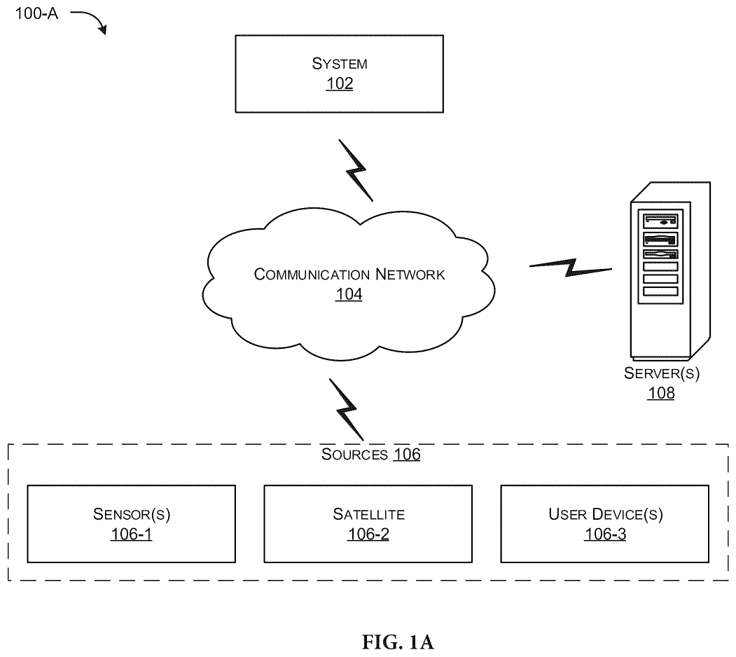

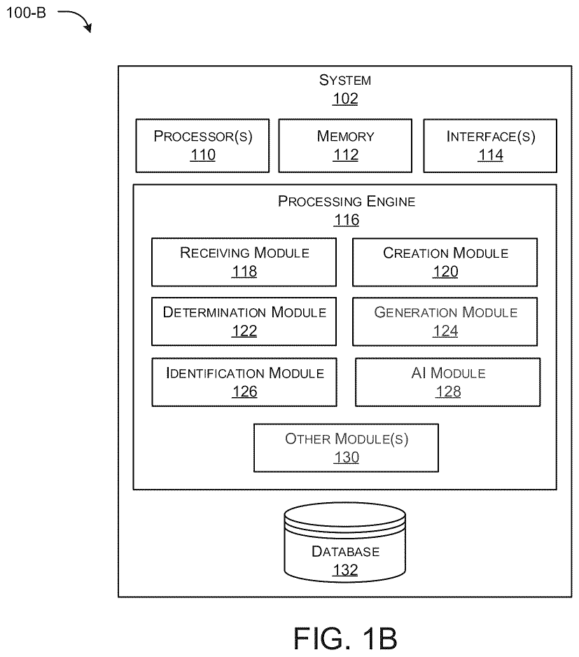

Various embodiments of the present disclosure will be explained in detail with reference to FIGS. 1A to 17.

FIGS. 1A and 1B illustrate an exemplary network architecture 100-A and an exemplary block diagram 100-B of a system 102 for implementing sustainability interventions in a social ecosystem, in accordance with an embodiment of the present disclosure.

Referring to FIGS. 1A and 1B, the system 102 for implementing sustainability interventions in the social ecosystem may include one or more processors 110, a memory 112, and an interface(s) 114. The one or more processors 108 may be implemented as one or more microprocessors, microcomputers, microcontrollers, digital signal processors, central processing units, logic circuitries, and/or any devices that manipulate data based on operational instructions. Among other capabilities, the one or more processor(s) 110 may be configured to fetch and execute computer-readable instructions stored in the memory 112 of the system 102. The memory 112 may store one or more computer-readable instructions or routines, which may be fetched and executed to predict damage of a virtual vehicle. The memory 112 may include any non-transitory storage device including, for example, volatile memory such as Random-Access Memory (RAM), or non-volatile memory such as Erasable Programmable Read-Only Memory (EPROM), flash memory, and the like.

In an embodiment, the system 102 may be communicatively connected to a plurality of sources 106 (collectively referred to as sources 106, hereinafter) via a communication network 104. The sources 106 may include, but not limited to, sensors 106-1, satellite 106-2, user devices 106-3 and the like. The communication network 104 may be wired communication means, or wireless communication means, or a combination thereof. In some embodiments, the wired communication means may include, but not limited to, wires, cables, data buses, optical fibre cables, and the like. In some embodiments, the wireless communication means may include, but not be limited to, telecommunication networks, Near Field Communication (NFC), Bluetooth, and the like. In some embodiments, the form factor of the data transmitted through the communication means may be any one or combination of including, but not limited to, analogue signals, electrical signals, digital signals, radio signals, infrared signals, data packets, and the like. The communication network 104 may include, by way of example but not limitation, at least a portion of one or more networks having one or more nodes, that transmit, receive, forward, generate, buffer, store, route, switch, process, or a combination thereof, etc. one or more messages, packets, signals, waves, voltage or current levels, some combination thereof, or so forth. The communication network 104 may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, or some combination thereof.

In an embodiment, the interface(s) 114 may include a variety of interfaces, for example, a variety of interfaces, for example, interfaces for data input and output devices, referred to as I/O devices, storage devices, and the like. The interface(s) 114 may facilitate communication of the system 102 with various devices coupled to it. The interface(s) 114 may also provide a communication pathway for one or more components of the system 102. Examples of such components include but are not limited to, processing engine(s) 116, and a database 132. The database 132 may include data that is either stored or generated as a result of functionalities implemented by any of the components of the processing engine(s) 116.

In an embodiment, the processing engine(s) 116 may be implemented as a combination of hardware and programming (for example, programmable instructions) to implement one or more functionalities of the processing engine(s) 116. In examples described herein, such combinations of hardware and programming may be implemented in several different ways. For example, the programming for the processing engine(s) 116 may be processor executable instructions stored on a non-transitory machine-readable storage medium and the hardware for the one or more processor(s) 110 may include a processing resource (for example, one or more processors 110), to execute such instructions. In the present examples, the machine-readable storage medium may store instructions that, when executed by the processing resource, implement the processing engine(s) 116. In such examples, the system 102 may include the machine-readable storage medium storing the instructions and the processing resource to execute the instructions, or the machine-readable storage medium may be separate but accessible to the system 102 and the processing resource. In other examples, the processing engine(s) 116 may be implemented by an electronic circuitry.

Further, the system 102 may be associated with a server 108 through the communication network 104. The server 108 may handle data processing and storage tasks for the system 102. The server 108 may be responsible for managing and storing large datasets, and facilitating complex computational tasks required for generating recommendations.

Further, the processing engine(s) 116 may include a receiving module 118, a creation module 120, a determination module 122, a generation module 124, an identification module 126, an AI module 128 and other module(s) 130. The other module(s) 130 may implement functionalities that supplement applications/functions performed by the processing engine(s) 116.

In an embodiment, the receiving module 118 may receive data associated with a plurality of thematic areas (collectively referred to as thematic areas, hereinafter) in the social ecosystem. The creation module 120 may be configured to create an indicator bank and a system's map. The determination module 122 may be configured to determine a value corresponding to each of indicators in the indicator bank. The generation module 124 may be configured to generate a first-level recommendation and a second-level recommendation. The identification module 126 and the AI module 128 may identify interrelationships between the indicators in each of the thematic areas using Artificial Intelligence (AI) models.

Referring back to FIGS. 1A and 1B, in an embodiment, the receiving module 118 may receive data associated with the thematic areas in the social ecosystem using a plurality of sources 106 associated with the system 102. The data may be collected from the sources 106 such as, but not limited to, sensors 106-1, satellite 106-2, user devices 106-3 and the like. The thematic areas may include sectors such as, but not limited to, water, energy, agriculture, health, education, and the like. The data collection process may include multiple methodologies such as, but not limited to, participatory rural appraisal, human-centered design, sensor-based monitoring, remote sensing and the like. The collected data may capture social, economic, environmental, and institutional dimensions of sustainability. Further, the data associated with the thematic areas may be stored in the database 132.

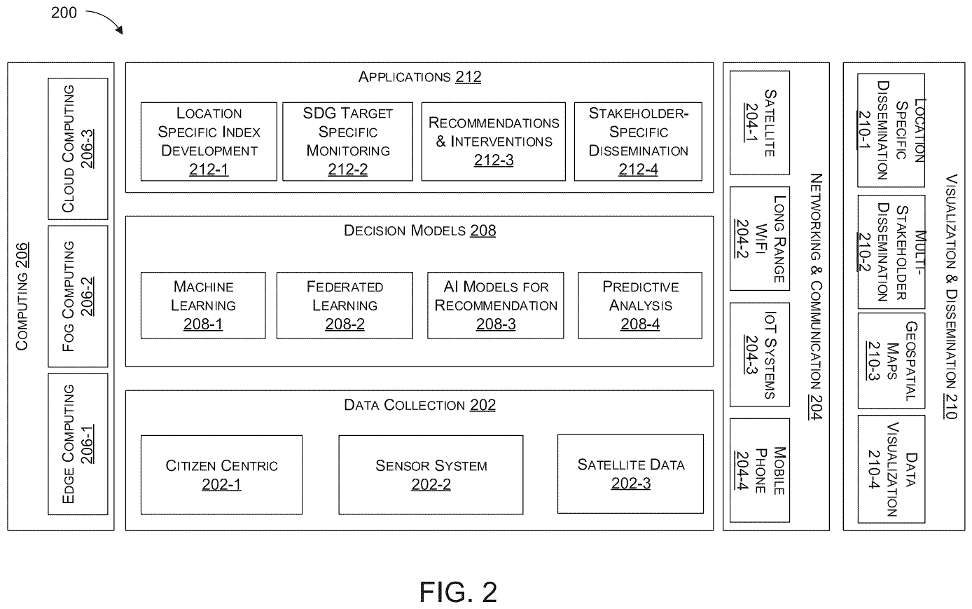

FIG. 2 illustrates an example block diagram 200 of the system architecture 200 for implementing the sustainability interventions in the social ecosystem, in accordance with an embodiment of the present disclosure.

Referring to FIG. 2, in an example embodiment, the system 102 may include a data collection module 202 for collecting data from different sources. The data may include citizen-centric 202-1 data, data from sensor systems 202-2 and satellite data 202-3. Further, the system architecture 200 may include networking and communication module 204 (e.g., communication network 104) consisting of multiple technologies such as satellite 204-1, long-range Wireless Infidelity (Wi-Fi) 204-2, IoT systems 204-3 and mobile phones 204-4. The system 102 may include a computing module 206 to process the data. The computing module 206 may include edge computing 206-1, fog computing 206-2 and cloud computing 206-3. Further, the system 102 may include decision models 208 such as machine learning 208-1, federated learning 208-2, Artificial Intelligence (AI) models for recommendation 208-3, and predictive analysis 208-4 to generate recommendations. The system 102 may include visualization and dissemination 210 for presenting and sharing the data. The visualization and dissemination 210 may include location-specific dissemination 210-1, stakeholder dissemination 210-2, multi-geospatial maps 210-3, and data visualization 210-4. Further, the system 102 may include applications 212 for processing the data. The applications 212 may include location-specific index development 212-1, Sustainable Development Goals (SDG) target-specific monitoring 212-2, recommendations & interventions 212-3 and stakeholder-specific dissemination 212-4.

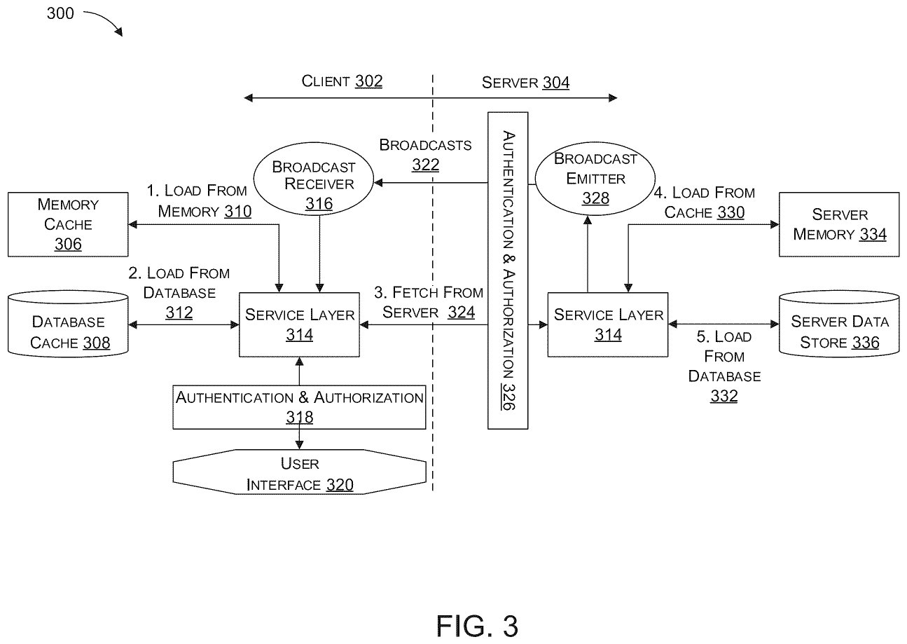

FIG. 3 illustrates a schematic representation 300 of data exchange between a client device 302 and a server 304, in accordance with an embodiment of the present disclosure.

Referring to FIG. 3, the client device 302 associated with the system 102 may request data, process information, and display results to a user. The server 304 (e.g., server 108) may be responsible for handling data requests, authentication, and storage management to ensure secure and efficient access to information. The client device 302 may retrieve data through multiple storage layers to improve performance. A memory cache 306 may store frequently accessed data to enable quick retrieval, and database cache 308 may be an intermediary storage. When a request is made by the user to the system 102 through the client device 302, the system 102 may load data from memory 310. If the required data is not available in the memory cache 306, the system 102 may retrieve data from database 312 (e.g., database 132). Once the requested data is fetched, a service layer 314 may process the retrieved information. To maintain security and control access, an authentication and authorization module 318 may verify user credentials and permissions before granting access to requested data. The verified data may be presented to the user through a User Interface (UI) 320 (e.g., interface 114). To facilitate communication between the client 302 and the server 304, a broadcast receiver 316 may transmits data using broadcasts 322 to the server 304. When the required data is unavailable on the client side, the system 102 may initiate a request to fetch data 324 from the server 304. The server 304 may process the request by verifying authentication through the authentication and authorization module 326. If the requested data is available in server memory 334, the data may be loaded from the cache 330. If the data is not in the cache, the system 102 may load the required information 332 from a server data store 336. The retrieved data may be processed by the service layer 314 and forwarded to the broadcast emitter 328, which may transmits the data back to the client 302.

Referring back to FIGS. 1A and 1B, in an embodiment, the creation module 120 may create an indicator bank. The indicator bank may include indicators corresponding to each of the thematic areas. The identification of indicators may include extensive research and literature reviews. An indicator localization process may ensure that the indicators are relevant to specific local contexts and Delphi Method may be applied for indicator localization to refine and validate the selection of indicators. The Delphi Method may ensure multi-stakeholder consultations to ensure indicator relevance and may aid in effective and context-specific indicator localizations. The data received from the sources 106 may be structured into a multidimensional array, where each row represents indicators related to different thematic areas, ensuring an organized and standardized dataset for further processing.

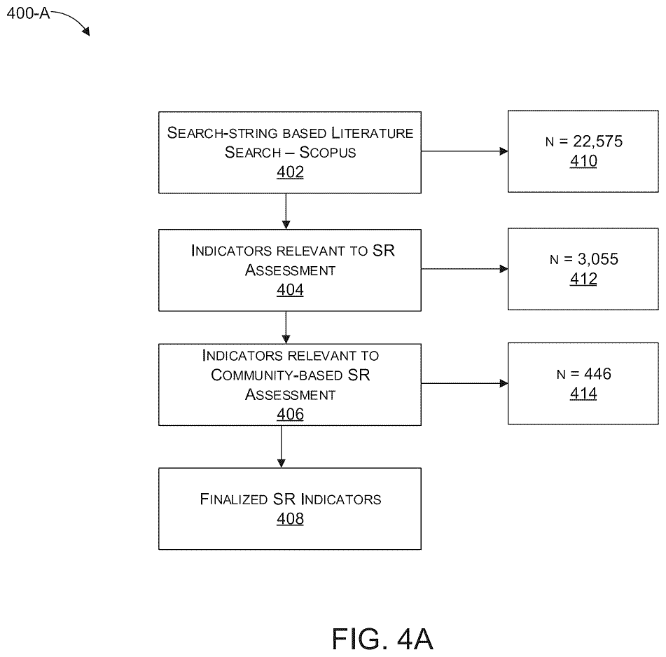

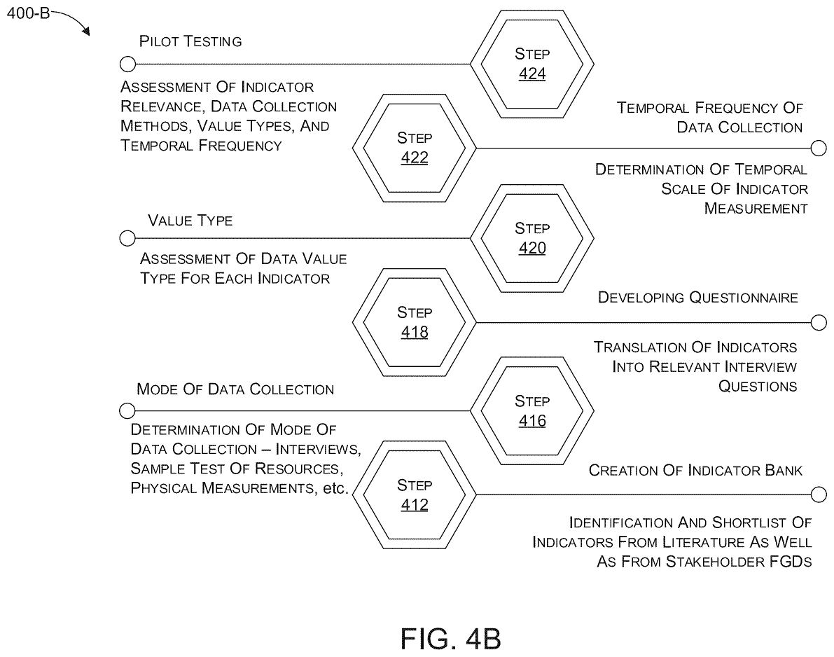

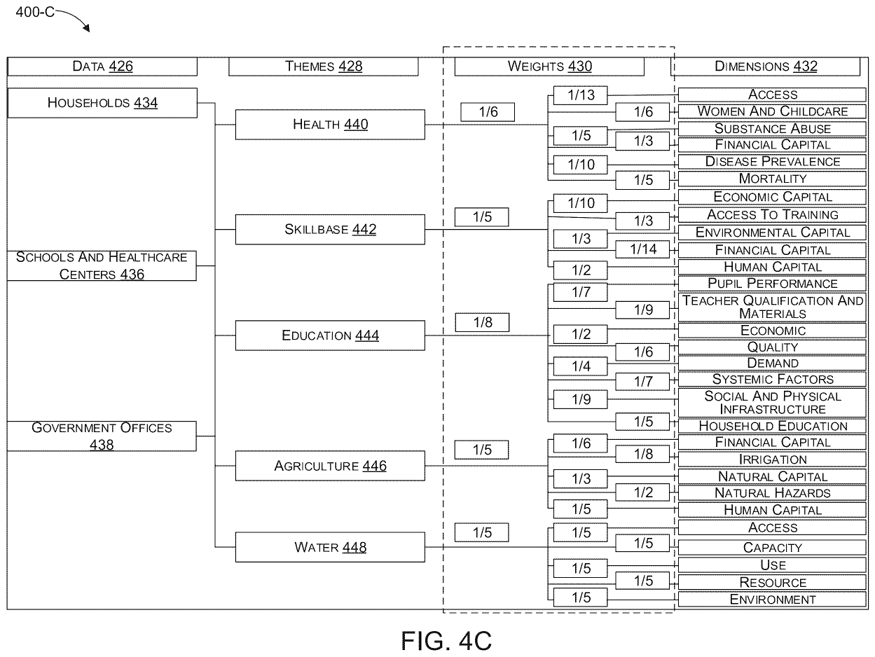

FIG. 4A illustrates an example flow chart 400-A of identifying the indicators, in accordance with an embodiment of the present disclosure.

Referring to FIG. 4A, at step 402, a search-string-based literature search may be conducted using database such as Scopus, Web of Science (WoS), Google Scholar, and the like, yielding 22,575 results (as indicated by step 410). At step 404, the results may be filtered to extract indicators relevant to sustainability and resilience (SR) assessment, reducing the number of relevant documents to 3,055 (as shown in step 412). The results may be filtered using a keyword search, where specific keywords such as sustainability, resilience, assessments and the like may be utilized to filter the results. At step 406, further screening may be performed to focus on indicators relevant to community-based SR assessment, narrowing the selection to 446 indicators (referenced by step 414). At step 408, the finalized SR indicators are identified, forming the core set of indicators for assessment.

FIG. 4B illustrates an example flow chart of a method 400-B for developing indicators for data collection, in accordance with an embodiment of the present disclosure.

Referring to FIG. 4B, at Step 412, creation of the indicator bank may include identification and shortlisting of indicators from literature as well as focus group discussions (FGDs) of stakeholders. At step 416, mode of data collection may be determined by selecting appropriate methods such as interviews, sample testing of resources, physical measurements and the like. At step 418, development of questionnaire may include translation of the indicators into relevant interview questions. At step 420, the assessment of data value type may be performed for each indicator. Further, at step 422, the temporal frequency of data collection may be determined, including determination of the temporal scale (e.g., weights) of indicator measurement. At step 424, pilot testing may be performed by assessment of indicator relevance data collection methods, value types, and temporal frequency to validate the selected indicators and develop the indicators for the indicator bank.

FIG. 4C illustrates a schematic representation 400-C of indicator data collection and weighting, in accordance with an embodiment of the present disclosure.

Referring to FIG. 4C, data sources 426 may include households 434, schools and healthcare centers 436, and government offices 438. The sources contribute to different themes 428, such as health 440, skillbase 442, education 444, agriculture 446, and water 448. Each theme may be assigned a specific weight 430 such as ⅙, ⅕, ⅛ and the like, reflecting relative significance. The themes may be further divided into dimensions 432 to capture specific aspects. For instance, health 440 may include access, women and childcare, substance abuse, disease prevalence and mortality, while skillbase 442 may include economic capital, access to training, environmental capital, financial capital and human capital. Education 444 may include pupil performance, teacher qualification, economic, quality, demand, systemic factors, household education and, financial capital, whereas agriculture 446 may include irrigation, natural capital, and human capital. Water 448 may include access, capacity, use, resource and environment. Assigning assign weights (e.g., temporal scale) to periodically measure each indicator may aid in understanding the progress of a community in terms of community sustainability and resilience.

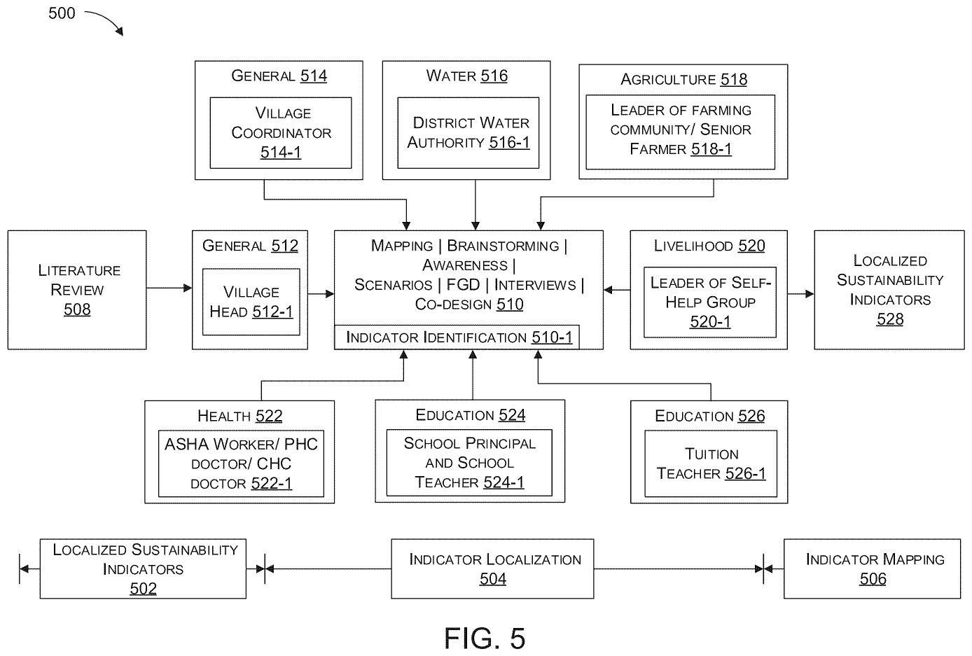

FIG. 5 illustrates an example block diagram 500 of a process for identifying the indicators, in accordance with an embodiment of the present disclosure.

Referring to FIG. 5, at step 502, the process may begin with identification of localized sustainability indicators, which may serve as the foundation for assessing sustainability at a community level. At step 508, a literature review may be conducted to gather relevant information. At step 510, indicator identification 510-1 may take place through mapping, brainstorming, awareness programs, FGDs, interviews, and co-design methodologies. Various thematic areas may have different stakeholders. For example, a village head 512-1 and a village coordinator 514-1 may correspond to a general thematic area 512, 514, a district water authority 516-1 may correspond to a water thematic area 516, and a leader of the farming community or senior farmer 518-1 may correspond to the agriculture thematic area 518. Similarly, a leader of a self-help group 520-1 may be associated with the livelihood thematic area 520, while professionals such as Accredited Social Health Activists (ASHA) workers, Primary Health Care (PHC) doctors, or Community Health Center (CHC) doctors 522-1 may correspond to the health thematic area 522. In education sector, school principals and teachers 524-1 may be associated with an education thematic area 524, and tuition teachers 526-1 may correspond to the education thematic area 526. The identified indicators may undergo localization 504 and mapping 506 to refine according to community-specific needs. At step 528, the finalized localized sustainability indicators may be established, aligning with the socio-economic and environmental conditions of the region.

Referring back to FIGS. 1A and 1B, in an embodiment, the determination module 122 may determine a value corresponding to each of the indicators. Each indicator within the indicator bank may be assigned the value based on the collected data. The system 102 may quantify qualitative data using Natural Language Processing (NLP) techniques, facilitating numerical representations and comparative analysis. The NLP techniques such as sentiment analysis, Term Frequency-Inverse Document Frequency (TF-IDF), keyword extraction, topic modeling, language translation, summarization and the like may be used to convert qualitative data into quantitative data. The quantitative data may be coded allowing numerical representation to carry out arithmetic operations such as index aggregation resulting in aggregated scores. The aggregated scores may be used for comparative analysis. The system 102 may evaluate whether each indicator value falls within a predefined range. The range may be obtained from historical data, scientific models, and expert recommendations to provide a benchmark for sustainability assessment.

In an embodiment, the generation module 124 may generate a first-level recommendation when the value of each of the indicators falls within the predefined range. A first-level recommendation may be generated when the value falls within the predefined range. The system 102 may iteratively check all indicators against the respective range. If the value exceeds or falls below the acceptable range, the system 102 may retrieve predefined interventions from recommendations stored in the database 132.

In an embodiment, the identification module 126 may identify interrelationships between the indicators in each of the thematic areas using a plurality of Artificial Intelligence (AI) models associated with an AI module 128 upon generation of the first-level recommendation. Various AI models such as, but not limited to, neural network models, machine learning models and the like may be applied to identify interrelationships. Additionally, statistical techniques, such as, but not limited to Multiple Correlation Coefficient (MCC), Canonical Correlation Analysis (CCA), Principal Component Analysis (PCA), and Factor Analysis, may be applied to identify interrelationships.

In an embodiment, the interrelationships may include at least one of one-to-one relationships, one-to-many relationships, and many-to-many relationships. For example, as air pollution levels rise, the number of respiratory diseases may increase, this corresponds to the one-to-one relationships. Further, Shifting to renewable energy may reduce carbon emissions, which in turn may lower air pollution and improve public health, this corresponds to one to many relationships. Further, deforestation may lead to biodiversity loss and soil degradation, which in turn may reduce agricultural productivity and a decline in agricultural output may contribute to food insecurity and economic instability, which can further drive deforestation, which may correspond to many-to-many relationships. The sustainability interventions may often impact multiple sectors, the system 102 may analyze the interrelationships between indicators to understand the broader implications of the interventions.

In an embodiment, the creation module 120 may create a system's map based on the identified interrelationships. The system's map is a visual and analytical tool that may help in understanding the complexity of sustainability challenges by depicting how indicators interact and influence one another. The system's map represents the relationships between different sustainability indicators within multiple thematic areas, such as environmental, economic, social, and governance sectors.

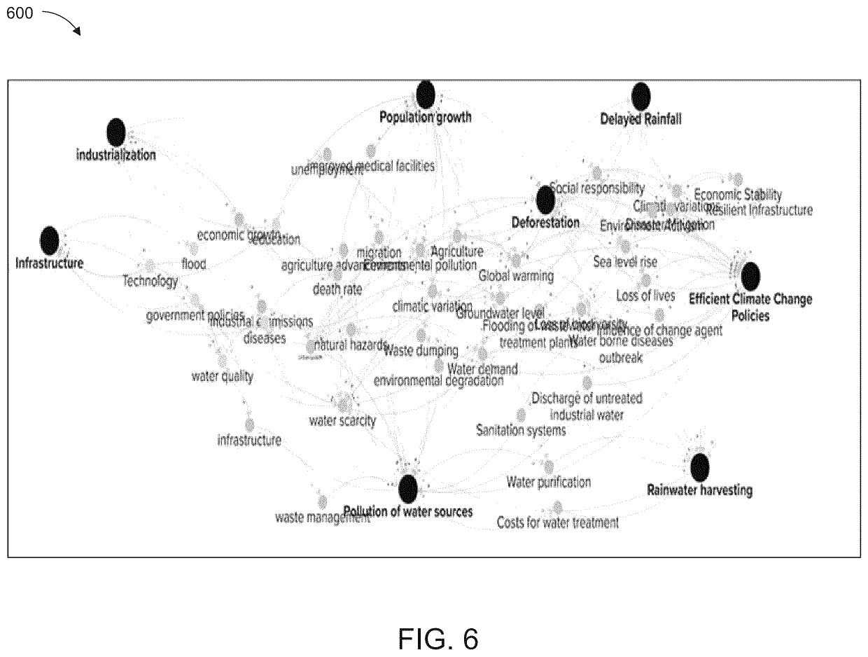

FIG. 6 illustrates an exemplary view of the system's map 600 generated by . . . during . . . , in accordance with an embodiment of the present disclosure.

Referring to FIG. 6, the system's map 600 may display the interrelationships between various sustainability indicators. Larger nodes may highlight key factors such as industrialization, deforestation, pollution of water sources, delayed rainfall, population growth, climate change policies, and the like, which may have multiple direct and indirect connections to other environmental and socio-economic variables. The smaller nodes may depict interconnected elements like water scarcity, infrastructure, agriculture, climate variations, environmental degradation, and the like indicating influence each other in a web of cause-and-effect relationships. The system's map 600 may identify synergies and trade-offs in sustainability challenges, aiding in effective decision-making and policy development.

Referring back to FIGS. 1A and 1B, in an embodiment, the generation module 124 may generate a plurality of deep structures (collectively referred to as deep structures, hereinafter) corresponding to each of the thematic areas based on the system's map 600 to classify the indicators of each of the plurality of thematic areas into synergies and trade-offs. Synergies may be the Indicators that positively influence one another. An improvement in one thematic area may lead to benefits in another thematic area. For example, increasing renewable energy use may lead to a reduction in air pollution, which may enhance public health. Trade-offs maybe the indicators that conflict with each other. The improvement in one thematic area may negatively impact another thematic area. For example, expanding mining operations may boost economic growth but also degrade local water resources.

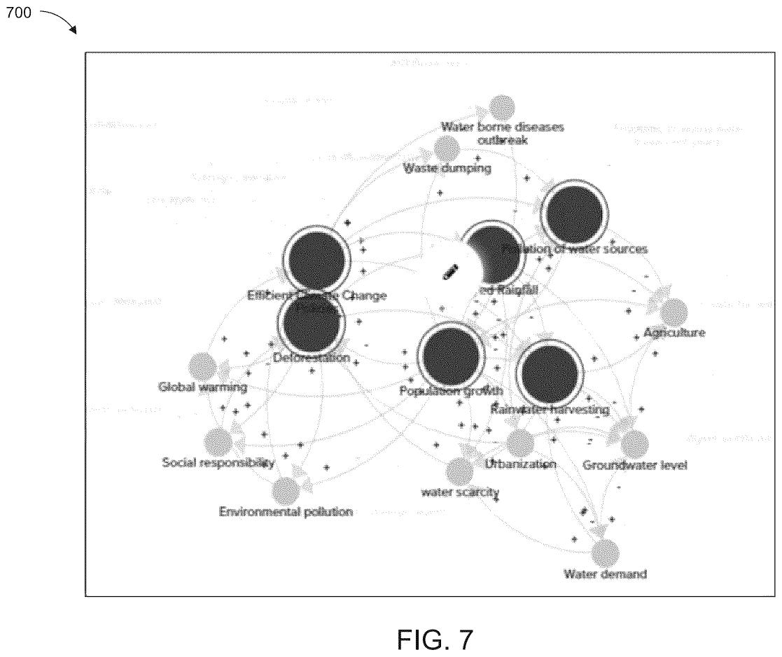

FIG. 7 illustrates an exemplary view of the deep structure 700, in accordance with an embodiment of the present disclosure.

Referring to FIG. 7, the deep structure may be generated from the system's map 600. The large nodes may indicate crucial elements such as efficient climate change policies, deforestation, population growth, pollution of water sources, delayed rainfall, rainwater harvesting and the like. The elements may be interconnected with other factors, as represented by the surrounding smaller nodes and linking lines, which may indicate synergies and trade-offs. Positive and negative influences may be marked with plus (+) and minus (−) signs, showing impact of different factors with one another. The deep structure may classify indicators into synergies and trade-offs, providing insights for sustainability interventions and policy recommendations.

Referring back to FIGS. 1A and 1B, in an embodiment, the generation module 124 may generate a second-level recommendation based on the system's map 600. The second-level recommendation are generated based on the synergies and trade-offs. The first-level and second-level recommendations are indicative of the sustainability interventions. The interventions that create positive cascading effects across multiple indicators may be given higher priority. For interventions that cause trade-offs, the system 102 may provide complementary actions to counterbalance negative effects. For example, if an economic growth initiative leads to environmental degradation, a conservation program may be recommended.

In an embodiment, the prioritization module may prioritize first level and second level recommendations based on at least two approaches using the AI models. In an embodiment, the at least two approaches for prioritizing the recommendations may include a system-defined prioritization and a user-defined prioritization.

Further, the system-defined prioritization may include creating a priority matrix based on the interrelationships identified between the indicators. The priority matrix may identify influence of the indicators with each other and may rank the indicators. Further, assigning priority levels to each of the interrelationships based on predefined criteria. The criteria may include strength of the correlation between indicators, historical trends, predictive insights generated by AI models and the like. For instance, if one indicator has a significant impact on another, that indicator may be given a higher priority level. Further, determining if the priority levels exceed a predefined threshold and prioritizing the first level recommendations and the second level recommendations upon a positive determination that the priority levels exceed the predefined threshold. However, if the priority levels do not exceed the predefined threshold, the system 102 may adjust the rankings based on the priority matrix to provide the recommendations.

In an embodiment, the system 102 may receive a set of indicator responses associated with the indicators. The indicator responses may be collected from surveys, expert-opinions, real-time feedback from the stakeholders and the like. Further, determining a sub-index score for each of the indicators based on the set of indicator responses. The sub-index score may represent performance of each of the indicators. Further, generating an index score by aggregating the sub-index scores for each of the indicators and comparing the sub-index scores and index scores against a set of predefined benchmarks. The benchmarks may be obtained from historical data stored in the database 132. Further, the system 102 may generate policies or policy recommendations based on the indicator responses, sub-index scores, and index scores. The policies generated by the system 102 may be used for user-defined prioritization. A user or a stakeholder may decide the priority based on which the policy recommendations generated by the system 102 The recommendations decided by the user may be essential to consider various local factors such as implementation timeframe (long-term or short-term), economic feasibility, administrative challenges, unexpected climate variability, and the like. Once prioritized, the user or the stakeholder may implement the sustainability recommendation.

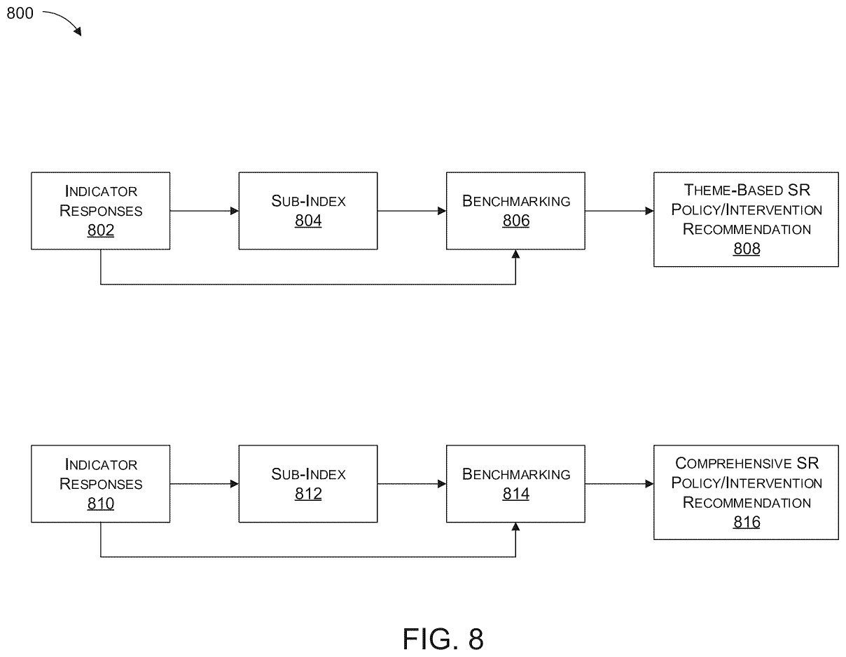

FIG. 8 illustrates an example block diagram 800 of a theme-based and comprehensive policy recommendations, in accordance with an embodiment of the present disclosure.

Referring to FIG. 8, at step 802 indicator responses may be collected. At step 804, the indicator responses may be categorized into relevant sub-index categories. At step 806, the indicator responses may be benchmarked against predefined standards. At step 808, a theme-based SR policy or intervention recommendation may be derived to address specific sustainability issues. Similarly, at step 810, the indicator responses may be collected and at step 812, the indicator responses may be categorized into sub-index. At step 814, the indicator responses may be benchmarked against the predefined standards. At step 816, a comprehensive SR Policy or intervention recommendation may be derived, integrating multiple thematic areas for a broad sustainability response.

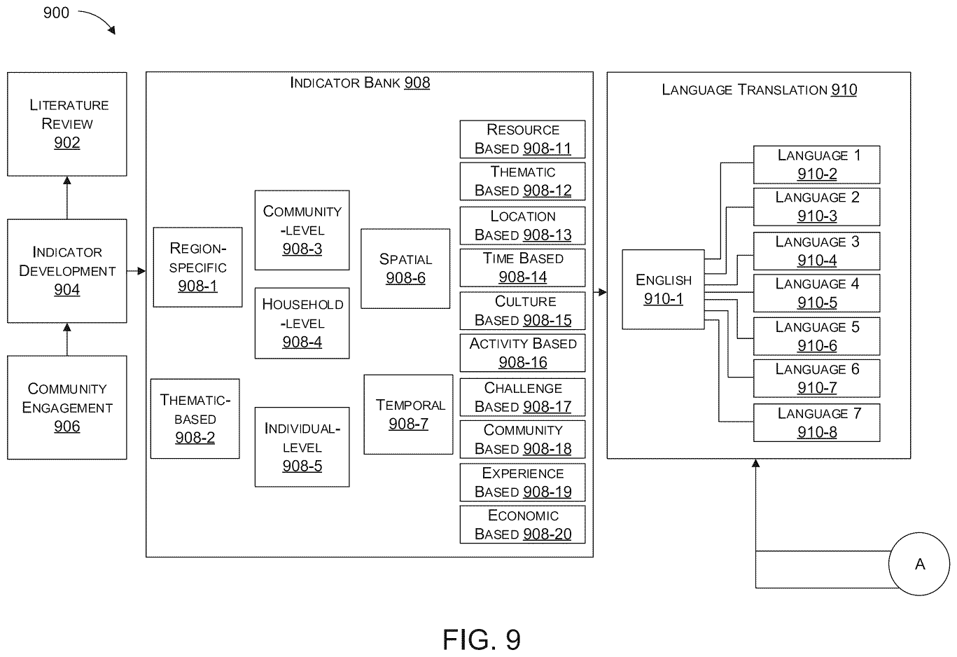

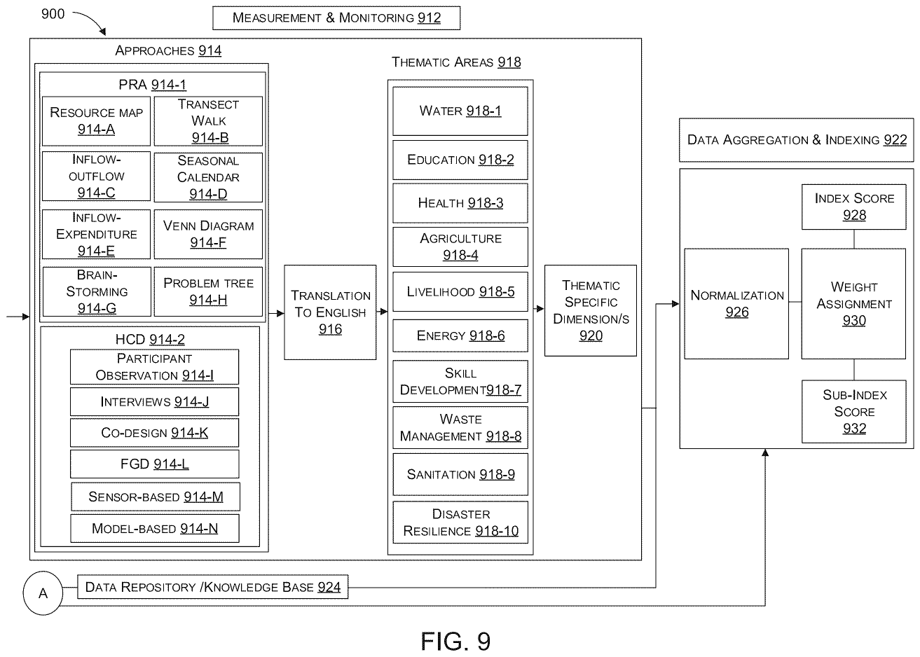

FIG. 9 illustrates an example flow diagram 900 of indicator assessment and data processing, in accordance with an embodiment of the present disclosure.

Referring to FIG. 9, in an exemplary embodiment, at step 902, the process may begin with a literature review, where existing studies, frameworks, and knowledge may be reviewed to inform the development of indicators. At step 904, indicator development may be carried out, where potential indicators may be identified and refined based on the literature review and expert inputs. At step 906, community engagement may be conducted to ensure that the indicators align with local contexts and stakeholder priorities. At step 908, the indicator bank may be created, categorizing indicators into different levels. The indicators may be grouped as region-specific 908-1, thematic-based 908-2, community-level 908-3, household-level 908-4, individual-level 908-5, spatial aspects 908-6 and, temporal variations 908-7. Further, the indicators may be grouped as resource-based 908-11, theme-based 908-12, location-based 908-13, time-based 908-14, culture-based 908-15, activity-based 908-16, challenge-based 908-17, community-based 908-18, experience-based 908-19 and economic-based 908-20.

At step 910, language translation may be carried out to ensure accessibility across diverse linguistic groups. English 910-1 may serve as the primary reference, and translations may be provided into multiple languages (910-2 to 910-8). At step 912, measurement and monitoring of the indicators may be implemented using various approaches 914 such as Participatory Rural Appraisal (PRA) 914-1 and Human-Centered Design (HCD) 914-2. The PRA 914-1 may include resource map 914-A, transect walks 914-B, inflow-outflow 914-C, seasonal calendar 914-D, inflow-expenditure 914-E, Venn diagrams 914-F, brain storming 914-G, problem tree 914-H. The HCD 914-2 may include participant observation 914-I, interviews 914-J, co-design sessions 914-K, Focus Group Discussions (FGD) 914-L, sensor-based 914-M and model-based 914-N. At step 916, the approaches may be translated to English. At step 918, key thematic areas may be identified, such as water 918-1, education 918-2, health 918-3, agriculture 918-4, livelihood 918-5, energy 918-6, skill development 918-7, waste management 918-8, sanitation 918-9, and disaster resilience 918-10. At step 920, thematic specific dimensions may be assigned to ensure that each area is evaluated using appropriate indicators. At step 922, data aggregation and indexing may take place to consolidate the collected data. At step 924, a data repository or knowledge base may be established to store and manage all collected data. Techniques such as normalization 926 may be used to standardize data, while weight assignment 930 may help prioritize different indicators based on their significance. The results may be compiled into index scores 928 and sub-index scores 932, which may provide structured insights for decision-making.

Referring back to FIGS. 1A and 1B, in an embodiment, the transmission module may transmit the prioritized recommendations to stakeholders associated with the social ecosystem for implementation of the sustainability interventions. The stakeholders may include, such as, but not limited to, policymakers, community organizations, government agencies, private sector entities and the like. The system 102 may ensure that each stakeholder receives tailored recommendations aligned with the respective thematic areas and sustainability objectives.

In an embodiment, the processor 110 may monitor and assess an impact of the implemented sustainability interventions in real-time. The system 102 may recollect the data for the indicators at predefined intervals and analyze changes in the indicator values. In an embodiment, the processor 110 may update the system's map 600 and recommendations based on real-time monitoring and assessing. New interrelationships may emerge as sustainability interventions progress, requiring periodic refinements to the recommendations. If certain interventions do not achieve the desired outcomes, the system 102 may generate revised recommendations. The feedback loop may ensure that sustainability interventions remain effective and adaptable to evolving challenges.

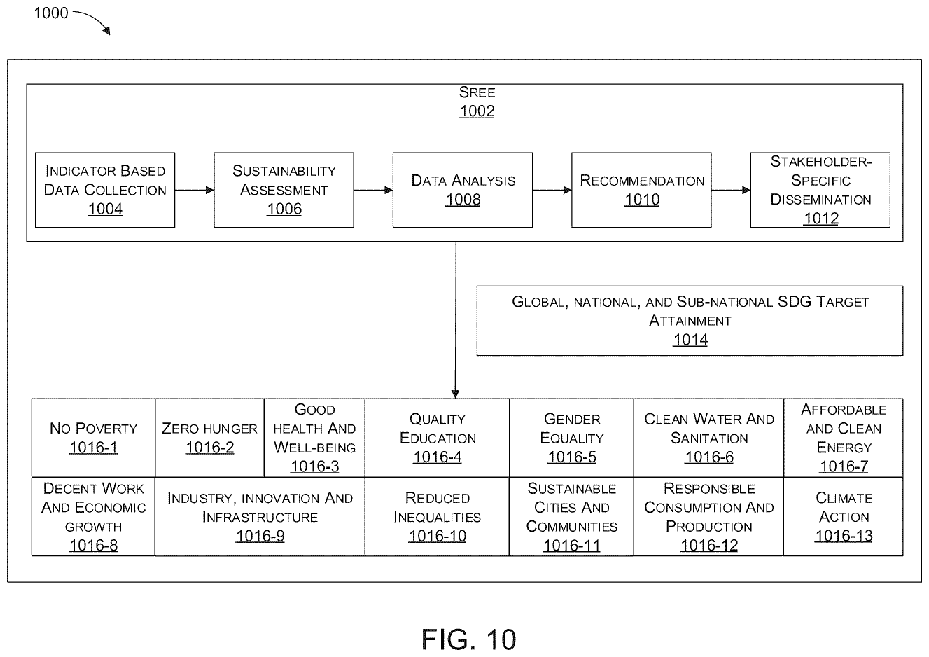

FIG. 10 illustrates a schematic representation 1000 of a Sustainability and Resilience for community Engagement and Empowerment (SREE) framework 1002, in accordance with an embodiment of the present disclosure.

Referring to FIG. 10, in an example embodiment, the SREE framework 1002 may be utilized for a structured approach to sustainability evaluation. The SREE framework 1002 may integrate multiple stages to ensure a comprehensive assessment of sustainability-related indicators. An indicator-based data collection 1004 may be conducted, where relevant sustainability data may be gathered using predefined indicators. A sustainability assessment 1006 may be carried out to analyze the collected data in terms of environmental, social, and economic sustainability dimensions. Further, data analysis 1008 may be applied to derive insights from the collected data and recommendations 1010 may be generated based on the findings from the data analysis 1008. A stakeholder-specific dissemination 1012 may be communicated to relevant stakeholders, including policymakers, community leaders, and the like. The stakeholder-specific dissemination 1012 may be tailored to different audiences to facilitate effective decision-making and implementation. The process of sustainability interventions may contribute to Global, National, and Sub-National Sustainable Development Goals (SDG) Target Attainment 1014. Further, the SREE framework 1002 may focus on multiple SDG-related areas, such as no poverty 1016-1, zero hunger 1016-2, good health and well-being 1016-3, quality education 1016-4, gender equality 1016-5, clean water and sanitation 1016-6, affordable and clean energy 1016-7, decent work and economic growth 1016-8, industry, innovation, and infrastructure 1016-9, reduced inequalities 1016-10, sustainable cities and communities 1016-11, responsible consumption and production 1016-12, climate action 1016-13 and the like.

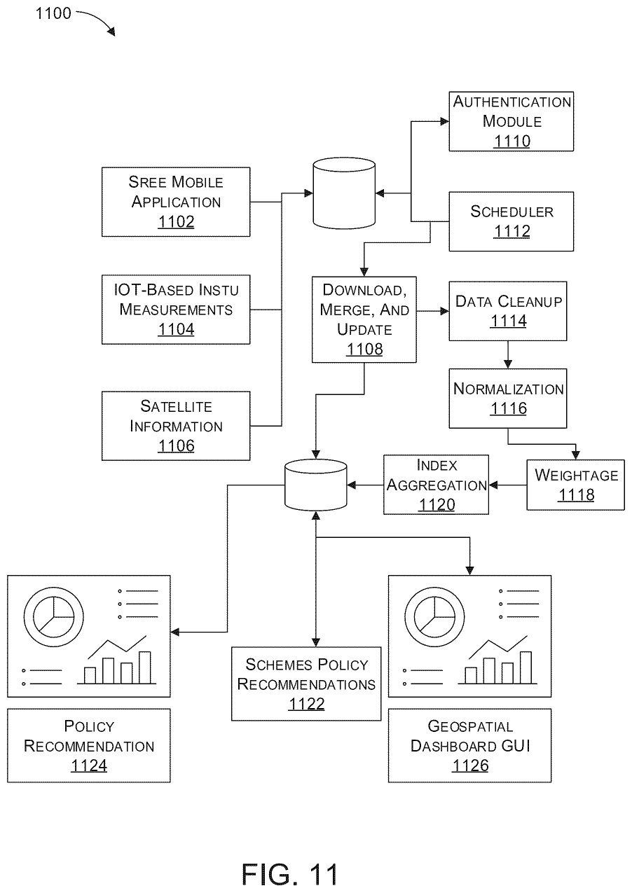

FIG. 11 illustrates an example block diagram of a data processing and analysis system 1100 using the SREE framework 1002, in accordance with an embodiment of the present disclosure.

Referring to FIG. 11, the data processing and analysis system 1100 may collect data from SREE Mobile Application 1102, IoT-Based in-situ measurements 1104, and satellite information 1106. The data processing and analysis system 1100 may include an authentication module 1110, a scheduler 1112. The data sources may be feed into a central database where they are processed through download, merge, and update module 1108 and may be transmitted to a data cleanup module 1114 to ensure accuracy. The data may undergo normalization 1116 and weightage 1118 adjustments before being aggregated through index aggregation 1120. The processed data may be used to generate schemes policy recommendations 1122, which may lead to policy recommendation 1124 and visualization through a geospatial Graphical User Interface (GUI) 1126.

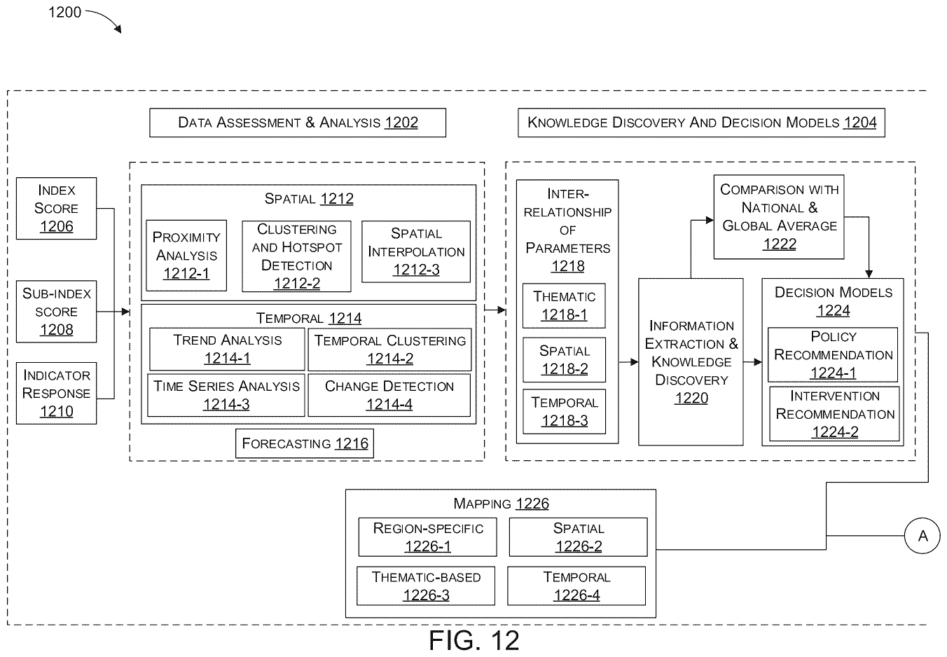

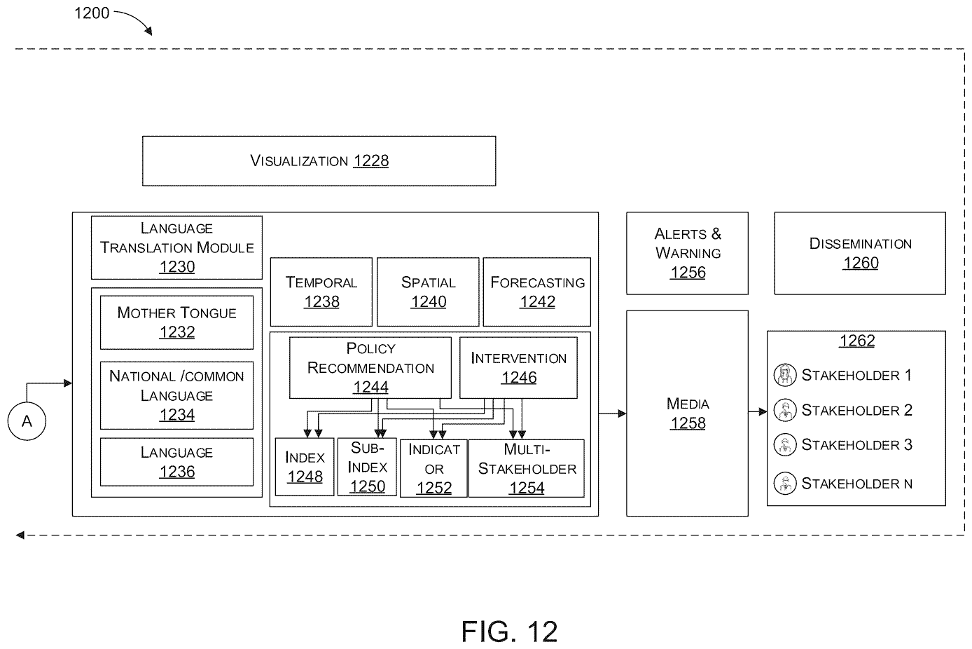

FIG. 12 illustrates an example flow chart 1200 of a method of dissemination of policy recommendations to stakeholders, in accordance with an embodiment of the present disclosure.

Referring to FIG. 12, in an example embodiment, at step 1202, data assessment and analysis may be performed, incorporating index score 1206, sub-index score 1208, and indicator response 1210. At step 1212, spatial analysis may be performed including proximity analysis 1212-1, clustering and hotspot detection 1212-2, and spatial interpolation 1212-3. At step 1214, temporal analysis may be performed, encompassing trend analysis 1214-1, temporal clustering 1214-2, time series analysis 1214-3, and change detection 1214-4. At step 1216, forecasting may be executed based on the assessed data. At step 1204, knowledge discovery and decision models may be applied, where inter-relationship of parameters 1218 may be analyzed, including thematic 1218-1, spatial 1218-2, and temporal 1218-3 parameters. At step 1220, information extraction and knowledge discovery may be performed and at step 1222, national and global averages may be compared. At step 1224, decision models may be utilized to generate policy recommendations 1224-1 and intervention recommendations 1224-2. At step 1226, mapping including region-specific mapping 1226-1, spatial mapping 1226-2, thematic-based mapping 1226-3, and temporal mapping 1226-4 may be performed. At step 1228, visualization of the processed data may be performed, incorporating a language translation module 1230, which may support mother tongue 1232, national/common language 1234, and other languages 1236. At steps 1238, 1240, and 1242, temporal, spatial, and forecasting visualizations, respectively, may be executed. At step 1244, policy recommendations may be processed and categorized into index 1248, sub-index 1250, indicator 1252, and multi-stakeholder 1254 categories. At step 1246, intervention measures may be determined based on the analyzed data. At step 1256, alerts and warnings may be generated and at step 1258, the alerts and warnings may be disseminated. At step 1260, the dissemination of results may be transmitted to relevant stakeholders 1262.

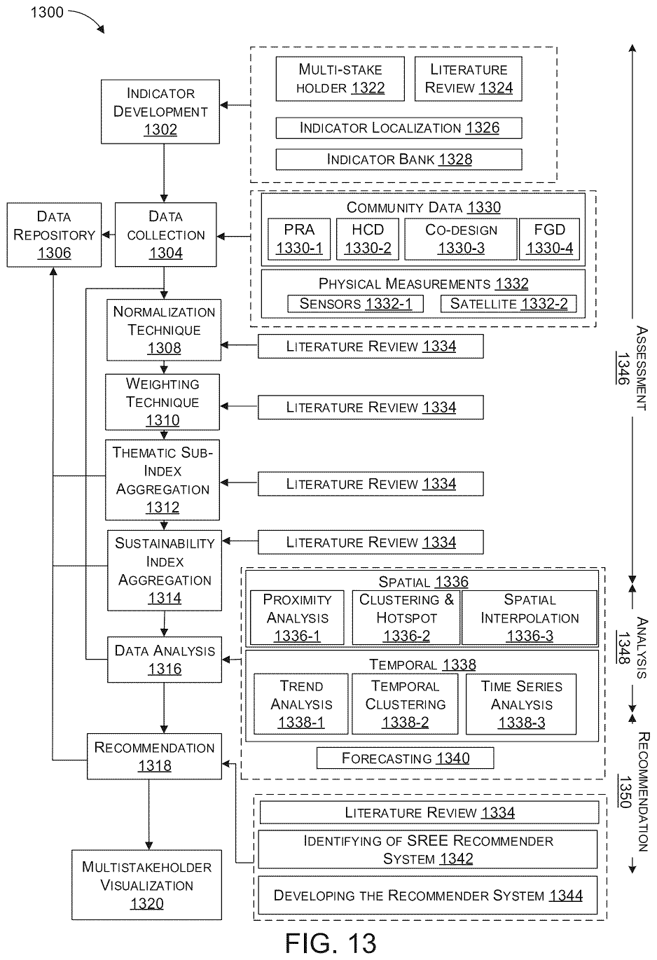

FIG. 13 illustrates an example flow chart 1300 of a method of multi-stakeholder visualization based on recommendations, in accordance with an embodiment of the present disclosure.

Referring to FIG. 13, in an example embodiment, at step 1302, indicators may be developed, involving multi-stakeholder engagement 1322, literature review 1324, indicator localization 1326, and the creation of the indicator bank 1328. At step 1304, data collection may be performed, sourcing information from community data 1330, which includes PRA 1330-1, HCD 1330-2, co-design 1330-3, and FGD 1330-4, as well as physical measurements 1332, incorporating sensors 1332-1 and satellite data 1332-2. Further, at step 1306, collected data may be stored in the data repository. At step 1308, normalization techniques may be applied to standardize the data. At step 1310, weighting techniques may be used to assign significance to various indicators. At step 1312, thematic sub-index aggregation may be performed and at step 1314, sustainability index aggregation may be performed. At step 1316, data analysis may be executed, using spatial analysis 1336 and temporal analysis 1338. Literature review 1334 may provide a basis for assessment 1346. The spatial analysis 1336 may include proximity analysis 1336-1, clustering and hotspot detection 1336-2, and spatial interpolation 1336-3. The temporal analysis 1338 may include trend analysis 1338-1, temporal clustering 1338-2 and time series analysis 1338-3. At step 1340, data forecasting may be performed. At step 1318, recommendations may be generated, using the literature review 1334, recommendations from identifying the SREE recommender system 1342 and developing the recommender system 1344. At step 1320, multi-stakeholder visualization may be implemented to enhance the interpretability and usability of the recommendations.

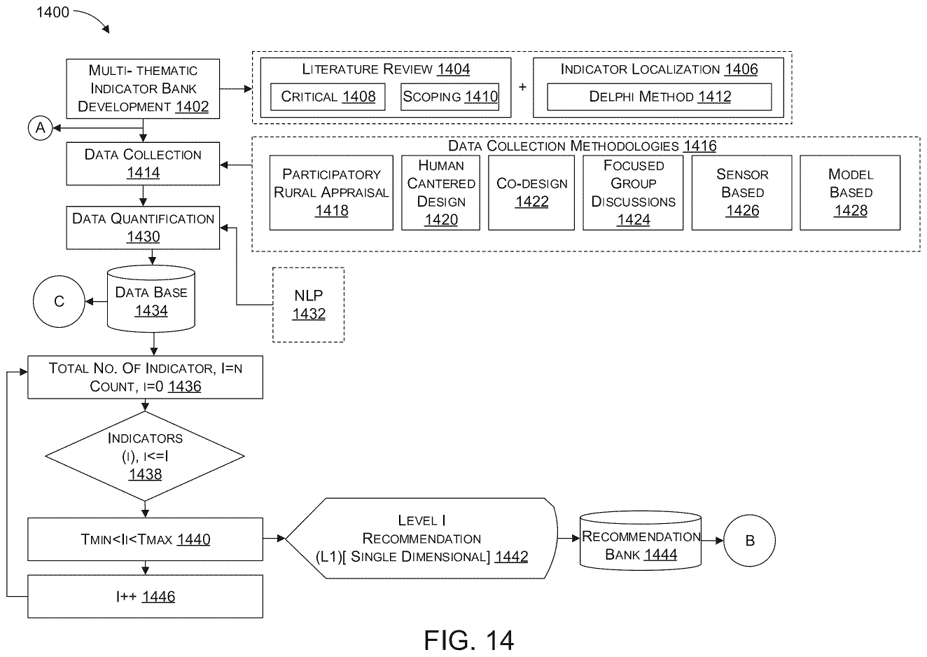

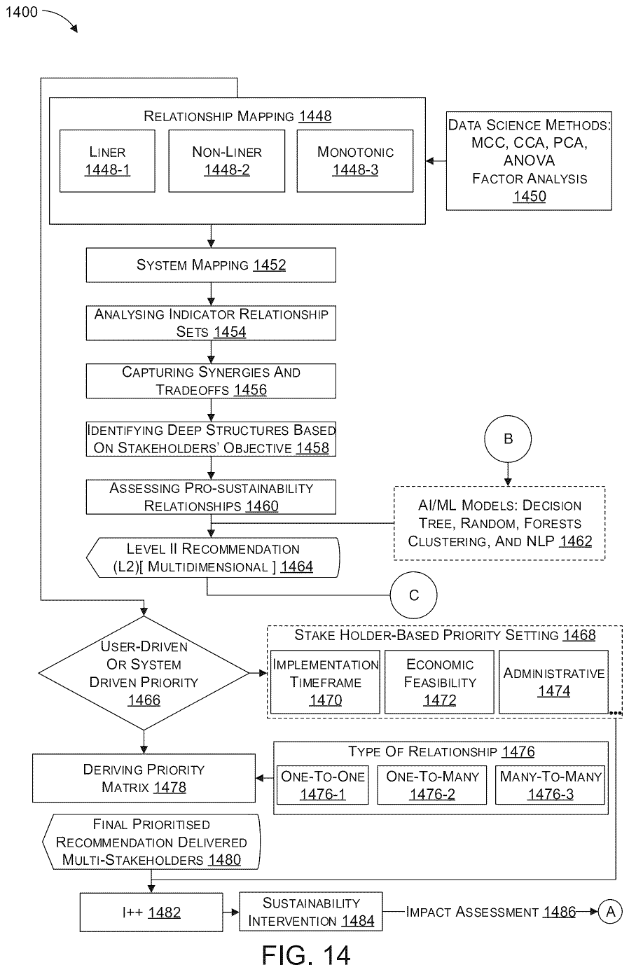

FIG. 14 illustrates an example flow diagram 1400 of a method for implementing sustainability interventions in a social ecosystem, in accordance with an embodiment of the present disclosure.

Referring to FIG. 14, at step 1402, a multi-thematic indicator bank may be developed for identifying and managing indicators relevant to sustainability assessment. At step 1404, literature review may be conducted including a critical analysis 1408, and scoping 1410. At step 1406, indicator localization may be performed using the Delphi Method 1412. At step 1414, data may be collected using various data collection methods 1416, including PRA 1418, HCD 1420, Co-Design 1422, FGD 1424, Sensor-Based data collection 1426, and Model-Based data collection 1428 for predictive analysis.

Further, at step 1430, data quantification may be performed for standardized of data using NLP 1432. At step 1434, the processed data may be stored in the database 132. At step 1436, the total number of indicators (I=N) may be determined, and an iteration process may be initiated with the initial count set to I=0. At step 1438, the iteration may begin where each indicator is assessed to determine its validity and relevance. At step 1440, each indicator may be checked against the acceptable range (Tmin<I<Tmax). At step 1446, if the indicator is not within the acceptable range, I may be increased until the indicator falls within the acceptable range. At step 1442, Level I recommendation (Single Dimensional Analysis) may be generated for the indicators that fall within the acceptable range. At step 1444, the Level I recommendations may be stored in a recommendation bank.

Further, at step 1448, relationship mapping may be conducted to analyze interaction of the indicators. Based on data type of the indicators (e.g., nominal, ordinal, interval/ratio) and data type pairing, a data science method may be used to determine the interrelationships of the indicators. At step 1450, various data science methods such as Matthews Correlation Coefficient (MCC), Canonical Correlation Analysis (CCA), Principal Components Analysis (PCA), Analysis of Variance (ANOVA), Factor Analysis and the like may be applied. The derived relationships may be categorized as Linear (constant rate of change between variables) 1448-1, Non-Linear (varying changes between variable) 1448-2, or Monotonic (one-directional change between variables) 1448-3. The categorization may aid in understanding the causal relationships between the indicators based on which the system's maps may be generated. At step 1452, the system generates system's map to establish interdependencies between indicators. At step 1454, the relationships between different indicator sets may be analyzed. At step 1456, the system's map may capture synergies and trade-offs. At step 1458, the system may identify deep structures based on stakeholders' objectives. At step 1460, the system may assess pro-sustainability relationships.

Further, at step 1464, Level II recommendations (Multi-Dimensional Analysis) may be generated using AI models such as decision tree, random, forest clustering and NLP. At step 1466, user-driven or system-driven priority recommendations may be generated. At step 1468, stakeholder-based priority recommendations may be performed, based on implementation timeframe 1470, economic feasibility 1472, and administrative feasibility 1474. At step 1476, different types of relationships may be considered, including One-to-One 1476-1, One-to-Many 1476-2, and Many-to-Many 1476-3 relationships. At step 1478, a priority matrix may be derived to rank and structure the recommendations. At step 1480, the final prioritized recommendations may be delivered to multi-stakeholders. At Step 1482, the iteration index may be incremented (I++) to continue processing all indicators. At step 1484, sustainability interventions may be implemented based on the final recommendations. At step 1486, an impact assessment may be conducted to evaluate the effectiveness of the interventions.

In an example implementation, to derive the second-level recommendations for water usage and water availability, the SREE system may use advanced data science methods to establish interrelationships among various sustainability indicators. The interrelationships may be categorized into one-to-one, one-to-many, and many-to-many relationships to analyze dependencies and correlations among the indicators.

Further, the one-to-one relationship may correlate two indicators at a time. For “N” indicators, the total number of such relationships is determined using the Binomial Coefficient formula:

$$( \frac{N}{r} ) = \frac{N !}{r ! ( N - r ) !} ,$$

where “r” is the size of the indicator relationship (for Coefficient formula: example, pairs, triplets, and the like). For example, the one-to-one relationships may include:

| Variable Set 1 | Variable Set 2 |
|---|---|
| Distance to nearest water | Average time spent fetching water |
| source | (minutes/day) |
| Availability of piped water | Percentage of the population with |
| connections | year-round access |
| Seasonal variations (dry vs. | Daily water availability per capita |
| wet season) | (liters) |
| Daily Water Usage (Litres) | No. of Openwells |
| Economic factors (e.g., water | Household water consumption |
| pricing policies) | (liters/day) |
| Water treatment plant | Bacterial contamination (e.g., E. coli |
| efficiency | levels) |

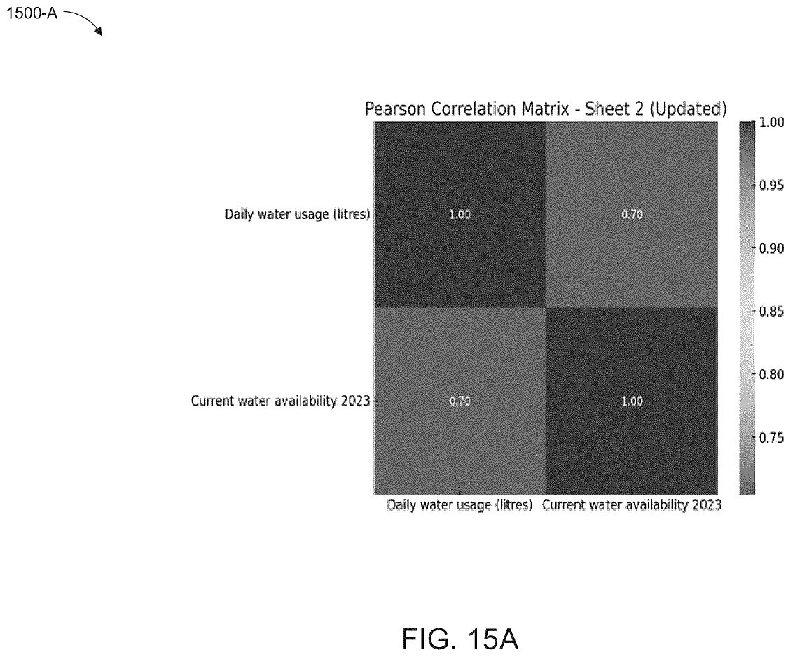

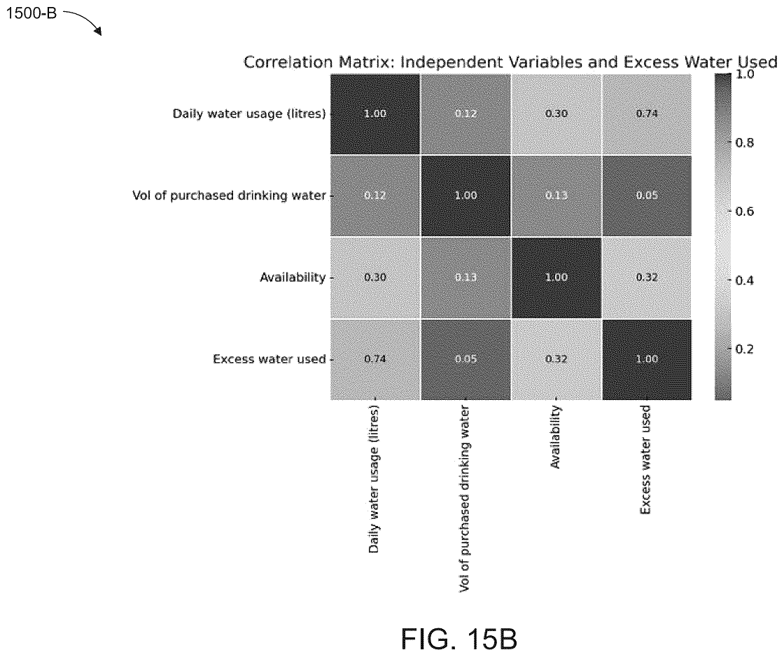

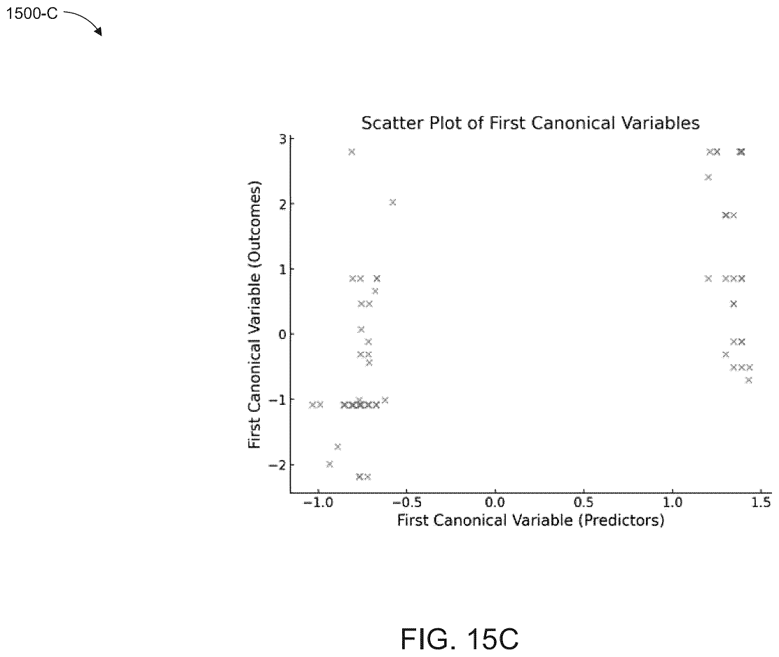

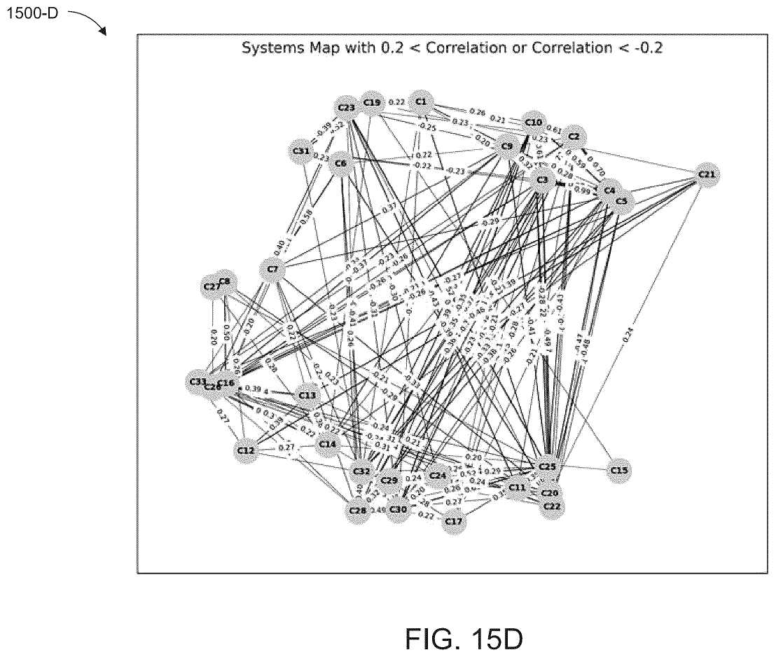

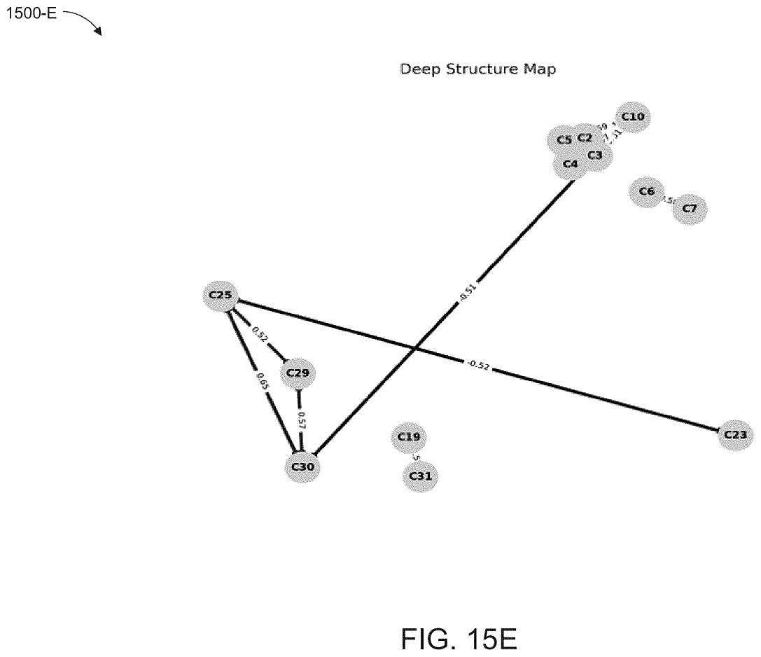

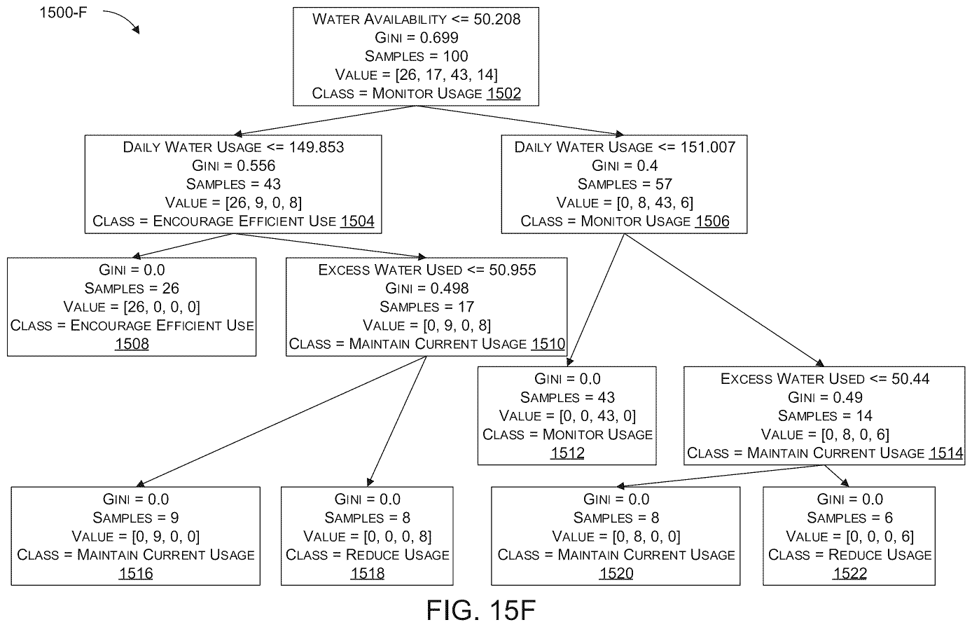

FIG. 15A illustrates a graphical representation of Pearson Correlation Matrix 1500-A for the one-to-one relationship, in accordance with an embodiment of the present disclosure.

Referring to FIG. 15A, the Pearson Correlation Matrix 1500-A may represent the statistical relationship between two variables: Daily Water Usage (liters) and Current Water Availability (2023). The diagonal elements are 1.00, indicating a perfect correlation of each variable with itself. The correlation coefficient between Daily Water Usage (liters) and Current Water Availability (2023) is 0.70, indicating a linear positive correlation. As water availability increases, daily water usage may increase. However, the correlation may be affected by other factors.

Further, the one-to-many relationship may correlate a single indicator to multiple dependent variables. The number of one-to-many relationships for “N” indicators is determined using: 2^{N-1}−1. For example, the one-to-many relationships may include:

| Indicator Set 1 | Indicator Set 2 |
|---|---|
| (Independent variable) | (Dependent variables) |
| Excess water used | Average water availability, Daily water usage, |
| | Recommended Water Usage Per Person, Volume |
| | of purchased drinking water |
| Average water | Excess water used, Daily water usage, |
| availability | Recommended Water Usage Per Person, Volume |
| | of purchased drinking water |
| Daily water usage | Excess water used, Average water availability, |
| | Recommended Water Usage Per Person, Volume |
| | of purchased drinking water |
| Recommended Water | Excess water used, Average water availability, |
| Usage Per Person | Daily water usage, Volume of purchased drinking |
| | water |
| Volume of purchased | Excess water used, Average water availability, |
| drinking water | Daily water usage, Recommended Water Usage |
| | Per Person |

FIG. 15B illustrates a graphical representation of the Pearson Correlation Matrix 1500-B for one-to-many relationships, in accordance with an embodiment of the present disclosure.

Referring to FIG. 15B, the Pearson Correlation Matrix 1500-B may indicate the one-to-many relationships between four variables: Dependent variable-Daily water usage (liters), Volume of purchased drinking water, Availability and Independent variable-Excess water used. The diagonal values are 1.00, indicating a perfect correlation of each variable with itself. The correlations and the interrelationships are as follows:

| | Corre- | | |
|---|---|---|---|
| | lation | Relationship | Type of |
| Variables | Value | Description | Relationship |
| Daily water usage | 0.12 | Weak positive | Linear |
| (liters) and Volume | | correlation (little | |
| of purchased | | association). | |
| drinking water | | | |
| Daily water usage | 0.3 | Weak positive | Monotonic |
| (liters) and | | correlation (mild | |
| Availability | | association). | |
| Daily water usage | 0.74 | Strong positive | Linear |
| (liters) and Excess | | correlation (higher water | |
| water used | | usage tends to increase | |
| | | excess water used). | |
| Volume of purchased | 0.13 | Weak positive | Non-linear |
| drinking water and | | correlation (little | |
| Availability | | association). | |
| Volume of purchased | 0.05 | Very weak positive | Linear |
| drinking water and | | correlation (almost no | |
| Excess water used | | association). | |
| Availability and | 0.32 | Moderate positive | Monotonic |
| Excess water used | | correlation (higher | |
| | | availability leads to | |
| | | increased excess water). | |

The strongest relationship may be between Daily water usage and Excess water used (0.74), indicating that inefficient water consumption leads to wastage. Water availability has a moderate effect on both daily usage (0.30) and excess water used (0.32), indicating that when more water is available, people tend to use more but not significantly. Volume of purchased drinking water has weak correlations with other factors, indicating external influence may affect the consumption.

Further, the many-to-many relationships may correlate between multiple “N” indicators using:

$$Total k - way relationships = ( \frac{N}{k} ) = \frac{N !}{k ! ( N - k ) !}$$

The many-to-many relationships may include:

| Variable Sets 1 | Variables Sets 2 |
|---|---|
| Size of agricultural land, | Total agricultural water consumption, |
| Number of irrigation systems | Crop yield per hectare, Soil moisture |
| installed, Distance to nearest | content |
| water source, Frequency of rainfall | |
| Water storage duration, material of | Water storage duration, material of |
| storage containers, distance from | storage containers, distance from |
| potential contamination sources, | potential contamination sources, |
| type of water source | type of water source |
| Number of functional water taps in | Average daily water usage per |
| the community, distance to nearest | household, time spent fetching water, |
| water distribution center, average | community satisfaction with water |
| household income, seasonal water | access |
| availability | |
| No. of Toilets, No. of Open Wells | Daily Household Water |
| | Consumption, Water for Livestock |
| | Use |

FIG. 15C illustrates a graphical representation of first Canonical Variables 1500-C for many-to-many relationships, in accordance with an embodiment of the present disclosure.

Referring to FIG. 15C, the first canonical variables may be derived from Canonical Correlation Analysis (CCA). Each point in scatter plot may represent an observation, indicating relationships between the first canonical variable of the predictors and outcomes. The first canonical correlation (ρ1=0.63) may represent the strongest association, explaining the majority of shared variance between the predictor and outcome sets. However, the second canonical correlation (ρ2=0.14) is weak, indicating that any additional relationships may contribute minimally. The third canonical correlation (ρ3=not a number (NaN)) may not interpretable due to constant residuals or insufficient variation in the data. The first canonical component may have a relationship: U1=a₁C2+a₂C11+a₃C25 and V1=b₁C33+b₂C10+b₃C10, where a₁, a₂, a₃: Canonical weights for predictors (C2, C11, and C25) and b₁, b₂, b₃: Canonical weights for outcomes (C33, C10). The canonical correlation of 0.63 may indicate a moderate relationship between the linear combinations U1 and V1.

Predictors (C2, C11, and C25) may represent variables contributing to the predictor canonical variable (U1) and the weights a₁, a₂, a₃ may quantify the contribution of each predictor to the combined variable. Similarly, outcomes (C33, C10) may represent variables contributing to the outcome canonical variable (V1) and the weights b₁, b₂, b₃ may quantify the contribution of each outcome to the combined variable. Further, C2, C11, C25 may form a combined predictor that correlates moderately with a combination of C33, C10. For example, higher values of a weighted combination of C2, C11, C25, are moderately associated with higher values of a weighted combination of C33, C10. Further, a weak canonical correlation (0.14) may indicate minimal relationship between the remaining variance in the predictor and outcome sets.

FIG. 15D illustrates an example system's map 1500-D for water availability and usage relationships, in accordance with an embodiment of the present disclosure.

FIG. 15E illustrates an example deep structure 1500-E for water availability and usage relationships, in accordance with an embodiment of the present disclosure.

Referring to FIGS. 15D and 15E, upon establishing the correlations between the indicators, the system's map (as shown in FIG. 15D) may be generated to visualize interdependencies. Positive correlation (+) may indicate that higher values of one variable lead to an increase in another. Negative correlation (−) may indicate that higher values of one variable lead to a decrease in another. Nodes (C1, C2, C3, etc.) may represent different variables, and lines may indicate strength and direction of the correlations between the variables. Further, the deep structure (as shown in FIG. 15E) may be derived to visualize relationships between significant variables. The deep structures may provide dependencies between key variables and correlated variables.

Further, the synergies and the tradeoffs may be obtained from the deep structure, based on the nature of correlation between the multi-variables. The interpretation of the correlations, may determine whether the correlations represent synergies or trade-offs. In some cases, a positive correlation may indicate synergies, while in other cases, the correlation may suggest trade-offs. Similarly, a negative correlation could signify trade-offs in one context or synergies in another context, depending on the sustainability goals and the variables.

FIG. 15F illustrates an example decision tree 1500-F for second level recommendation, in accordance with an embodiment of the present disclosure.

Referring to FIG. 15F, the decision trees may be used to derive second level recommendations based on the identified synergies and tradeoffs. Class in the decision tree may represent the recommendations derived for the input data. Key recommendations may include monitoring usage 1502, 1506, 1512, which may be advised when daily water usage is moderate but water availability is high, to prevent unnecessary overuse. Further, recommendations may include encouraging efficient use 1504, 1508, which may be recommended when both daily usage and availability are low, promoting the optimal utilization of limited resources. Additionally, recommendations may include maintaining current usage 1510, 1514, 1516, and 1520 that may as the default recommendation for scenarios that do not meet the conditions for other specified recommendations. Further, another recommendation may include reducing usage 1518, 1522, which may be suggested for cases with high daily water consumption and excessive water use, indicating overconsumption.

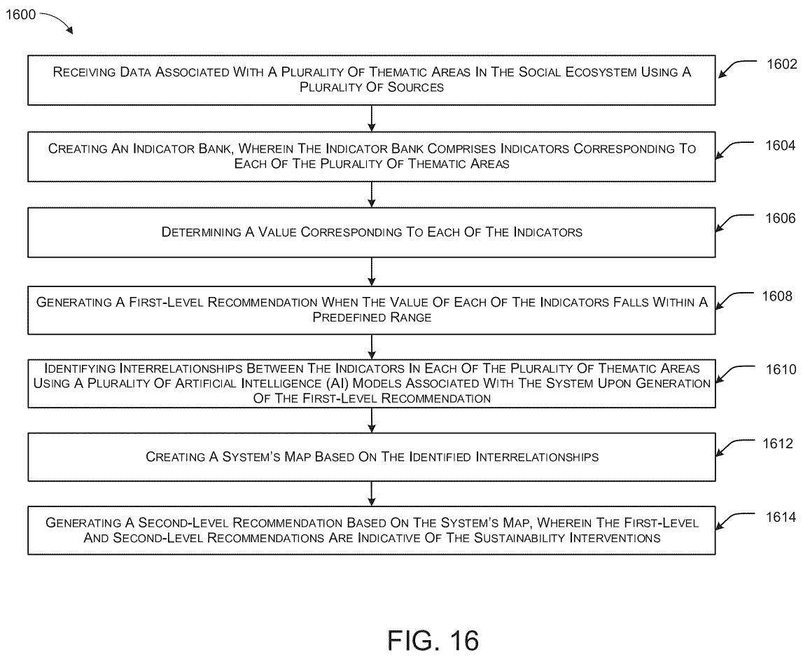

FIG. 16 illustrates a flow diagram illustrating the method 1600 for implementing sustainability interventions in the social ecosystem, in accordance with an embodiment of the present disclosure.

Referring to FIG. 16, at block 1602, the method 1600 may include receiving, the data associated with the thematic areas in the social ecosystem using the plurality of sources 106.

At block 1604, the method 1600 may include creating the indicator bank. The indicator bank may include the indicators corresponding to each of the thematic areas.

At block 1606, the method 1600 may include determining the value corresponding to each of the indicators.

At block 1608, the method 1600 may include generating the first-level recommendation when the value of each of the indicators falls within the predefined range.

At block 1610, the method 1600 may include identifying the interrelationships between the indicators in each of the thematic areas using the AI models upon generation of the first-level recommendation

At block 1612, the method 1600 may include creating the system's map based on the identified interrelationships.

At block 1614, the method 1600 may include generating the second-level recommendation based on the system's map. The first-level and the second-level recommendations may be indicative of the sustainability interventions.

Thus, the present disclosure proposes a system (e.g., 102 as represented in FIGS. 1A and 1B) and a method (e.g., 1600 as represented in FIG. 16) for implementing the sustainability interventions in the social ecosystem. By incorporating correlation techniques and AI-based recommendation models, the system 102 and the method 1600 aim to provide a robust, effective, and flexible solution identifying consumption patterns, predicting inefficiencies, and offering actionable recommendations for sustainable resource management.

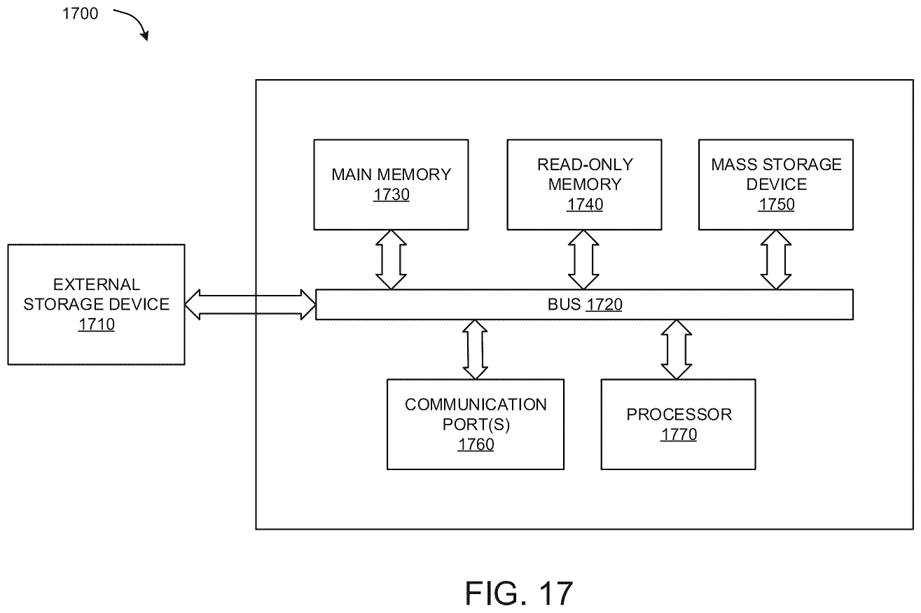

FIG. 17 illustrates a block diagram of an example computer system 1700 in which or with which embodiments of the present disclosure may be implemented.

As shown in FIG. 17, the computer system 1700 may include an external storage device 1710, a bus 1720, a main memory 1730, a read-only memory 1740, a mass storage device 1750, communication port(s) 1760, and a processor 1770. A person skilled in the art will appreciate that the computer system 1700 may include more than one processor and communication ports. The processor 1770 may include various modules associated with embodiments of the present disclosure. The communication port(s) 1760 may be any of an RS-232 port for use with a modem-based dialup connection, a 10/100 Ethernet port, a Gigabit or 10 Gigabit port using copper or fibre, a serial port, a parallel port, or other existing or future ports. The communication port(s) 1760 may be chosen depending on a network, such a Local Area Network (LAN), Wide Area Network (WAN), or any network to which the computer system 1700 connects. The main memory 1730 may be random access memory (RAM), or any other dynamic storage device commonly known in the art. The read-only memory 1740 may be any static storage device(s) including, but not limited to, a Programmable Read Only Memory (PROM) chips for storing static information e.g., start-up or basic input/output system (BIOS) instructions for the processor 1770. The mass storage device 1750 may be any current or future mass storage solution, which may be used to store information and/or instructions.

The bus 1720 communicatively couples the processor 1770 with the other memory, storage, and communication blocks. The bus 1720 can be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1770 to the computer system 1700.

Optionally, operator and administrative interfaces, e.g. a display, keyboard, and a cursor control device, may also be coupled to the bus 1720 to support direct operator interaction with the computer system 1700. Other operator and administrative interfaces may be provided through network connections connected through the communication port(s) 1760. In no way should the aforementioned exemplary computer system 1700 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure provides a system for implementing sustainability interventions, enabling data-driven decision-making and optimized resource allocation.

The present disclosure provides a scalable and adaptable system, allowing customization based on user-defined parameters and evolving sustainability goals.

The present disclosure provides a multi-layered approach to prioritizing sustainability recommendations, ensuring effective policy formulation and strategic intervention planning.

The present disclosure provides an integrated data collection method, utilizing various sources for comprehensive sustainability assessments.

The present disclosure provides a dynamic visualization and dissemination, facilitating real-time monitoring and stakeholder engagement.

We claim:

1. A method for implementing sustainability interventions in a social ecosystem, the method (1600) comprising:
receiving by one or more processors associated with a system data associated with a plurality of thematic areas in the social ecosystem using a plurality of sources associated with the system;
creating, by the one or more processors an indicator bank, wherein the indicator bank comprises one or more indicators corresponding to each of the plurality of thematic areas;
determining by the one or more processors a value corresponding to each of the one or more indicators;
generating, by the one or more processors, a first-level recommendation when the value of each of the one or more indicators falls within a predefined range;
identifying, by the one or more processors, interrelationships between the one or more indicators in each of the plurality of thematic areas using a plurality of Artificial Intelligence (AI) models associated with the system upon generation of the first-level recommendation;
creating, by the one or more processors, a system's map based on the identified interrelationships; and
generating, by the one or more processors, a second-level recommendation based on the system's map, wherein the first-level and second-level recommendations are indicative of the sustainability interventions.

2. The method as claimed in claim 1, wherein the interrelationships comprise at least one of one-to-one relationships, one-to-many relationships, and many-to-many relationships.

3. The method as claimed in claim 1, further comprises generating, by the one or more processors (110), a plurality of deep structures corresponding to each of the plurality of thematic areas based on the system's map to classify the one or more indicators of each of the plurality of thematic areas into synergies and trade-offs, wherein the second-level recommendation are generated based on the synergies and trade-offs.

4. The method as claimed in claim 1, further comprising:
prioritizing, by the one or more processors, the first level and second level recommendations based on at least two approaches using the plurality of AI models; and
transmitting, by the one or more processors, the prioritized recommendations to one or more stakeholders associated with the social ecosystem for implementation of the sustainability interventions.

5. The method as claimed in claim 3, wherein the at least two approaches for prioritizing the recommendations comprises a system-defined prioritization and a user-defined prioritization.

6. The method as claimed in claim 6, wherein the system-defined prioritization comprises:
creating, by the one or more processors, a priority matrix based on the interrelationships identified between the one or more indicators;
assigning, by the one or more processors, priority levels to each of the interrelationships based on a predefined criteria;
determining, by the one or more processors, if the priority levels exceed a predefined threshold; and
prioritizing, by the one or more processors, the first level recommendations and the second level recommendations upon a positive determination that the priority levels exceed the predefined threshold.

7. The method as claimed in claim 6, wherein the user-defined prioritization comprises:
receiving, by one or more processors, a set of indicator responses associated with the one or more indicators;
determining, by the one or more processors, a sub-index score for each of the one or more indicators based on the set of indicator responses;
generating, by the one or more processors, an index score by aggregating the sub-index scores for each of the one or more indicators;
comparing, by the one or more processors, the sub-index scores and index scores against a set of predefined benchmarks; and
generating, by the one or more processors, one or more policies based on the indicator responses, sub-index scores, and index scores, wherein the generated one or more policies is utilized for user-defined prioritization.

8. The method as claimed in claim 3, comprises monitoring and assessing, by the one or more processors, an impact of the implemented sustainability interventions in real-time.

9. The method as claimed in claim 8, comprises updating, by the one or more processors, the system's map and recommendations based on real-time monitoring and assessing.

10. A system for implementing sustainability interventions in a social ecosystem, the system (102) comprising:
one or more processors; and
a memory operatively coupled to the one or more processors, wherein the memory comprises processor-executable instructions, which, when executed, cause the one or more processors to:
receive data associated with a plurality of thematic areas in the social ecosystem using a plurality of sources associated with the system;
create an indicator bank, wherein the indicator bank comprises one or more indicators corresponding to each of the plurality of thematic areas;
determine a value corresponding to each of the one or more indicators;
generate a first-level recommendation when the value of each of the one or more indicators falls within a predefined range;
identify interrelationships between the one or more indicators in each of the plurality of thematic areas using a plurality of Artificial Intelligence (AI) models associated with the system upon generation of the first-level recommendation;
create a system's map based on the identified interrelationships; and
generate a second-level recommendation based on the system's map, wherein the first-level and the second-level recommendations are indicative of the sustainability interventions.
